(19) United States
(12) Patent Application Publication
(10) Pub. No.: US 2008/0033889 A1
(43) Pub. Date: Feb. 7, 2008

(54) Bond order direct transaction confirmation system

(75) Inventors: James A. Tappan, Oklahoma City, OK (US); Tommy J. Hannon, Edmond, OK (US); Jacob L. Massey, Oklahoma City, OK (US); James B. Rucker, Satellite Beach, FL (US); Christopher W. Trammell, Edmond, OK (US); David L. Trammell, Chickasha, OK (US)

Correspondence Address: DUNLAP CODDING & ROGERS, P.C., PO BOX 16370, OKLAHOMA CITY, OK, 73113, US

(73) Assignee: Bondtrac, Inc.

(21) Appl. No.: 11/498,386

(22) Filed: Aug. 3, 2006

(51) Int. Cl. G06Q 40/00

(52) U.S. Cl. 705/36 R

(57) ABSTRACT

An information system for enabling a buyer subscriber and a seller subscriber to directly communicate, negotiate and order financial instruments, particularly fixed income instruments, without the need for an intermediary or inter-dealer broker. The information system is adapted to publish real-time bond offerings, provide search capabilities to allow users to locate bond offerings meeting specific criteria, send real-time notification of offerings entering the marketplace in which a user has a registered interest, manage and negotiate order privileges, provide a network for real-time communication between counter-parties in a transaction, and allow direct communication between a fully disclosed buyer subscriber and a fully disclosed seller subscriber. Also, the information system can cooperate or be integrated with existing industry systems, such as inventory management systems to import offering information, and back-office systems to export transaction information.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Currently, investors that purchase bonds through a broker may have the purchase price of the bonds increased by three or four different markups from the price for which the original owner of the bonds sold them. For example, in order to complete one transaction, a middleman must purchase the bond from the seller (paying a clearing fee), mark up the price of the bond for a slight trade profit, and sell the bond to a broker-dealer buyer (paying another clearing fee). The broker-dealer must then mark up the price of the security for a profit on the trading desk, mark up the price for a profit to the broker, and then sell the bond to the investment client (paying a third clearing fee). This results in significant additional costs to the end consumer. Furthermore, there is no standard mark up legally or ethically set, based on size and risk of the transaction. Often each intermediary (e.g., a inter-dealer broker, broker-dealer, electronic communications network (“ECN”)/alternative trading system (“ATS”) or middleman) arbitrarily sets a mark up based on tacit acceptance rather than time consuming and potentially gainless research for fairness and relative value. The fixed income market has always operated “over the counter” without a centralized exchange, and with geographically diverse market makers, brokers and investors and over 2 million individual securities issued and outstanding.

The intermediated solution for purchasing bonds through inter-dealer brokers and anonymous trading platforms, where either an inter-dealer broker or another brokerage firm takes a middle position in the transaction, increases the cost of ordering through price markups and additional clearing costs. Therefore, a need exists for a disintermediated system which allows buyers and sellers to openly and directly negotiate thereby eliminating the need for a middleman.

There is also a need for a more reliable, efficient and secure system for assisting dealers with their bond transactions. A traditional tool in the bond market is the telephone. The current telephonic method, to Applicants' knowledge, accounts for approximately 85% of securities traded in the municipal, corporate, government agency, CD and other illiquid fixed income markets. While many bond market participants still obtain pre-trade discovery of price and availability via the telephone, and sometimes via fax and email, such communication methods can be unreliable, inefficient and unsecure. Most of the telephone, fax and email traffic is not encrypted. Further, busy traders are often not available to take a telephone call or must play telephone ‘tag.’ Also, telephone call recordings can be difficult and expensive to access and use. Faxes can get misplaced or garbled. Email traffic can get overlooked or even erroneously filtered as ‘spam.’ Moreover, voice, fax and email traffic can be difficult to track and link back to specific trades. For these reasons, communications via telephone, facsimile, and mail has proven to be less than optimum.

Currently, there are various different business models being pursued for pre-trade discovery and transaction in the bond markets. Most are anonymous and any resulting transaction is generally brokered with some being post-trade disclosed. They include traditional voice brokering and electronic systems which are auction systems, cross-matching systems, inter-dealer systems, single-dealer systems, and multi-dealer systems.

While these various legacy systems exist in the bond market, it is Applicants' belief that the systems can be improved upon to reduce the cost and increase the amount of participation in the process. Many of the prior art systems are based on business models that add significant costs to the process in the form of price markups and added clearing costs. These costs are generally attributable to additional middlemen being brought into the transaction. Also, these systems lack disclosure of the identity of the counter-parties, and do not allow for negotiations directly between the parties because they are brokered or anonymous. As such, generally only a limited selection of offerings are available for execution. Also, few of the systems are distributed through the pubic Internet, and therefore are not widely accessible without an expensive leased terminal.

For example, some pre-trade information is available through the Bloomberg, Reuters, or Thomson workstation services. However, to Applicants' knowledge, these systems require firms to pay high annual subscription costs for each user that needs access to these systems. Most firms cannot afford to provide an expensive workstation terminal to each potential bond market participant in the firm. Rather, these tools are purchased and made available only to the highest function users or high-end traders in each firm who justify the cost of such a system by their larger production. Further, the terminals may be shared among numerous users, thereby resulting in uncertainty of user identity. As such, there is a need for a system which can broadly and economically be used by multiple subscribers who can benefit by greater access to information and more efficient transactions in the fixed income market.

Further, current systems experience problems of incomplete access to all pre-trade quotes. Many of the current systems distribute their information through the World Wide Web using static web pages. This technology is inherently client request-driven. Unless the user is constantly manually refreshing the page, the information displayed on a web page may change on the server side without the user seeing these updates reflected on his display. Significant problems, such as broken trades, result when traders and brokers attempt to trade based on stale or non-live information. Therefore, a need exists for a system which provides and refreshes information on a real-time basis through low cost public internet delivery.

Another problem is that there is no one system to Applicants' knowledge which aligns the fragmented supply of securities and data into a single distribution channel. Generally, the large securities firms are the major providers of inventory in the bond market. They are frequently found to be owners either independently or through consortium of the various electronic trading systems. As such, competing, non consortium dealers in the market often will not list their inventory on a competitor's platform. Further, many firms are not technologically capable of making their offerings available on more than one platform without the possibility of over-committing and selling the same block of bonds to multiple buyers. Therefore, there is a need for a neutral, independent communication system which can be used efficiently by multiple participants.

Another problem is that none of the current systems to Applicants' knowledge provide an inherent capability for electronic negotiation between potential buyers and sellers during the order process. One of the major advantages of voice trading is that traders can often negotiate a dealer concession or better price based on a variety of factors. It is Applicants' understanding based on customer feedback that traders that regularly trade using the telephone are able to negotiate better pricing more than 50% of the time in certain fixed income markets. However, such direct negotiation between the counter-parties is not generally possible in any trading system that is an inter-dealer brokered or anonymously cross-matched. Those systems provide limited opportunities for the buyer to negotiate a lower price since they are not communicating with the owner of the security but are only communicating with an intermediary attempting to broker the bonds. More importantly, the seller can hardly feel incented to give best pricing to an anonymous buyer with unknown potential for repeat purchases and larger aggregated volume. As such, the lack of an adequate negotiation mechanism and non-disclosure restricts current systems to non-negotiable or limited publication of pricing and availability. Therefore, buyers using such systems may not see all securities that are offered for sale. This reduces the view of supply in the market to a smaller percentage of the securities available for sale in the secondary market at any given time. Therefore, a need exists for a system having a flexible, electronic communication mechanism whereby the counter-parties can openly and directly communicate.

Also, to Applicants' knowledge, many of the current systems do not integrate well with existing systems and applications in use by securities firms for inventory management, trade order management, or clearing in the front, middle, and back office of such securities firms. This lack of integration or interoperability with existing systems creates problems since offerings and trades must be re-keyed or exported and imported from one system into another. This also means that busy traders must choose either a) to spend a great deal of their time keeping their disparate systems simultaneously up to date, or b) to accept that their offerings will quickly become stale and non-actionable. Therefore, there is a need for a system which is effectively and efficiently integratable with the existing inventory management, order management, and clearing systems of securities firms.

Taken together, the problems discussed above have slowed the adoption of electronic transactions in the bond market and in other illiquid markets. Widespread adoption in such markets will not take place until an efficient and cost-effective system is available that solves the above mentioned problems and increases the efficiency of transactions, especially in the bond market, thereby saving market participant's time and costs. It is to such a system, and methods for implementing and using the same, that the present invention is directed.

### SUMMARY OF THE INVENTION

In general, the present invention relates to an electronic system for enabling communication between potential buyers and sellers in an effort to assist such parties in consummating a trade. More particularly, the present invention, similar to a telephone, is an information system that enables seller subscribers and buyer subscribers to directly negotiate and consummate trades, without the need for an intermediary or inter-dealer broker. Preferably, the system displays information related to financial instruments.

In one embodiment, the information system is specifically adapted for offerings of fixed income instruments, such as for example, but not by way of limitation, U.S. or foreign treasury bonds, municipal bonds, corporate bonds, agency bonds, government sponsored enterprise (GSE) bonds, preferred securities, convertible bonds, mortgage backed securities, mid-term notes, debentures, mortgages, asset-backed securities, Certificates of Deposits (CDs), Guaranteed Investment Contracts (GICs), or the like. The general term “bond” is also used herein interchangeably with the term “fixed income instrument.”

In general, the information system of the present invention may include many features, such as publishing real-time offerings, providing search capabilities to allow users to locate offerings meeting specific criteria, sending real-time notification of new offerings entering the marketplace in which a user has a registered interest, managing and negotiating trade privileges, allowing definition of buyer classes for price distributions, providing a network for real-time communication between counter-parties in a transaction, and/or allowing direct negotiation between fully disclosed trading partners. Also, the information system can cooperate or be integrated with existing industry systems, such as inventory management systems to import offering information, and back-office systems to export transaction information.

In one embodiment, the information system of the present invention includes a host server in communication with seller subscriber systems associated with the seller subscribers, and-buyer subscriber systems associated with the buyer subscribers. The host server stores, or otherwise has access to, listings corresponding to offerings of the seller subscribers, which are directly searchable by the buyer subscribers. The host server also stores, or otherwise has access to, an entity identity for each of the seller subscribers and buyer subscribers. During a transaction between one of the seller subscribers and one of the buyer subscribers, the host server provides the entity identity for each party to the other so that the identity of the counter-parties involved is fully disclosed. However, the information system does not match seller listings with buyer orders.

By providing fully-disclosed direct access between counter-parties, the information system of the present invention disintermediates the order process. Rather than acting as a broker in every trade, the information system serves as an open, fully disclosed communication network where buyer subscribers and seller subscribers can directly interact. Directly connecting the counter-parties in the transaction is the most efficient and inexpensive method. It mirrors the traditional method of transacting over the telephone, and further maximizes the efficiency of the order process by exchanging all of the necessary information electronically and providing additional tools and features not available through traditional or current systems. This also helps achieve significant goals of increasing transparency of transactions and reducing the cost to investors, especially in the over-the-counter bond markets.

Moreover, the host server of the information system is preferably operated by an independent third party entity which is not owned or operated by a brokerage entity (one in the business of buying or selling financial instruments), or a consortium. Promotion of the information system by a non-brokerage, non-consortium controlled, independent third-party entity better ensures that the information system does not take a position in the trade but simply connects buyer subscribers and seller subscribers through a neutral communication network similar to traditional telephonic methods. This avoids the competitive issues that have influenced some broker-dealers to avoid platforms owned by other brokerage firms.

Also, in one embodiment, the information system of the present invention further encourages participation by offering the automation of order privilege management. One of the challenges of dealer-to-dealer interaction is the management of relationships and accounts between firms. Many firms, and positioning traders within these firms, will not participate on a system if they are not given total control over who can see and purchase offerings from them. The information system of the present invention provides a customizable, multi-tier, pricing distribution option which allows a participating seller subscriber to specify who can view and purchase from the seller subscriber's inventory listed on the information system. The seller subscriber also has the ability to define multiple levels of pricing that may be made available to different classes or groups of buyers. This capability reflects the reality in the market of preferred pricing given because of existing business or personal relationships. Also, better pricing is often given to larger firms, firms with high buying power, or frequent customers that on average buy and sell larger blocks of financial instruments.

By providing a neutral and diverse system which can be efficiently and effectively utilized by numerous sellers, the information system can include offerings from multiple sources onto a single platform. This in turn allows for more competitive pricing and greater competition between seller subscribers listing the same or like securities for sale. The present invention increases the efficiency of participants having access to the system by providing savings in time and acquisition costs instead of more time consuming and costly current methods of searching, comparing and communicating through either telephone conversations, or shopping individual systems separately to find what is available and at what price.

Another optional feature of the present invention is that the information system employs real-time distribution of pre-trade and transaction information, rather than depending upon the seller subscriber and the buyer subscriber to work from ‘snap-shot’ information displayed on a web page. Communication and messaging technologies which now exist or which are later developed can be utilized by the information system to allow the buyer subscribers and the seller subscribers to send and receive information in real-time via their buyer subscriber systems and seller subscriber systems. In one embodiment, the buyer subscriber system transmits order requests and the seller subscriber system transmits order responses to communicate details of offerings and orders back and forth to one another in real-time through the information system. This provides the information system of the present invention with a communication mechanism.

Further, to facilitate real-time negotiations, the information system of the present invention provides identity awareness and actionable offerings through a presence indicator. Preferably, the host server of the information system maintains a connection with every seller subscriber logged onto the host server. When the seller subscriber is logged on, the host server provides the presence indicator to indicate to the buyer subscribers that the listing associated with the logged on seller subscriber is executable and that the seller subscriber is available for ordering or negotiation for that listing.

The present invention computerizes the fixed income order handling process to provide significant time and cost savings, broader participation and competition, more efficient data entry and price discovery, and direct and open negotiations between sellers and buyers. These advantages, in turn, result in better selection and more consistent and accurate prices to bond investors. As such, the present invention introduces a fully disclosed and low cost bond order system that will increase the efficiency and transparency of bond transactions by providing buyer subscribers with relevant information related to a large number of fixed income securities, that can be ordered immediately, electronically, and without need for repeated presale telephonic conversations or scattered servicing to confirm availability and current pricing together with a real-time communication system that allows a potential buyer and a potential seller to communicate with each other in an effort to consummate a trade.

The various objects and features discussed above, together with other objects and features of novelty which characterize the invention, are discussed and illustrated in further detail herein, and are pointed out with particularity in the claims.

### BRIEF DESCRIPTION OF THE DRAWINGS

FIG. 1 is a block diagram of an information system which is constructed in accordance with the present invention.

FIG. 2 illustrates one embodiment of a log-in window of the information system.

FIGS. 3-5, 6C, 6D and 20 cooperate to illustrate one embodiment of a seller interface of the information system; in particular:

FIG. 3 illustrates one embodiment of an “Inventory Manager” window of the seller interface.

FIG. 4 illustrates one embodiment of a “My Inventory” window of the seller interface.

FIG. 5A illustrates one embodiment of an “Add My Inventory” window of the seller interface.

FIG. 5B illustrates in more detail a “Standard Permission” input means of the “Edit My Inventory” window depicted in FIG. 5A.

FIG. 6C illustrates one embodiment of “Buyer Ordering Permissions Granted/Requested” of the Seller interface selecting the granted tab.

FIG. 6D illustrates one embodiment of a “Buyer Ordering Permissions Granted/Requested of the Seller interface selecting the Requested tab.

FIGS. 6A, 6B, 7-19 cooperate to illustrate one embodiment of a buyer interface of the information system, in particular:

FIG. 6A illustrates one embodiment of a “My Ordering Permissions Received/Pending” window of the buyer interface selecting the received tab.

FIG. 6B illustrates one embodiment of “My Order Permissions Received/Pending” window of the buyer interface selecting the pending tab.

FIG. 7 illustrates one embodiment of a “Quick Search” means of the buyer interface.

FIGS. 8A-8B illustrate one embodiment of a “Ticker Wizard” of the buyer interface.

FIG. 9 illustrates one embodiment of a customized parameter search ticker of the buyer interface, and a presence indicator provided therein.

FIG. 10 illustrates one embodiment of a “Detail” sub-screen of a “Description” screen of the buyer interface.

FIG. 11 illustrates one embodiment of a “Call Schedule” sub-screen of the “Description” screen of the buyer interface.

FIG. 12 illustrates one embodiment of an “Agents” sub-screen of the “Description” screen of the buyer interface.

FIG. 13 illustrates one embodiment of a “Material Events” sub-screen of the “Description” screen of the buyer interface.

FIG. 14 illustrates one embodiment of a “Notes” sub-screen of the “Description” screen of the buyer interface.

FIG. 15 illustrates one embodiment of a “Calculator” screen of the buyer interface.

FIG. 16 illustrates one embodiment of a “History” screen of the buyer interface.

FIG. 17 illustrates one embodiment of a “Competing Offerings” screen of the buyer interface.

FIG. 18 illustrates one embodiment of a “Contact” screen of the buyer interface.

FIG. 19 illustrates one embodiment of an “Order” screen of the buyer interface.

FIG. 20 illustrates one embodiment of an “Order” screen of the seller interface depicted in FIGS. 3-5, 6C and 6D.

FIGS. 21 illustrates one embodiment of an “Order History” window for the information system.

### DETAILED DESCRIPTION OF THE INVENTION

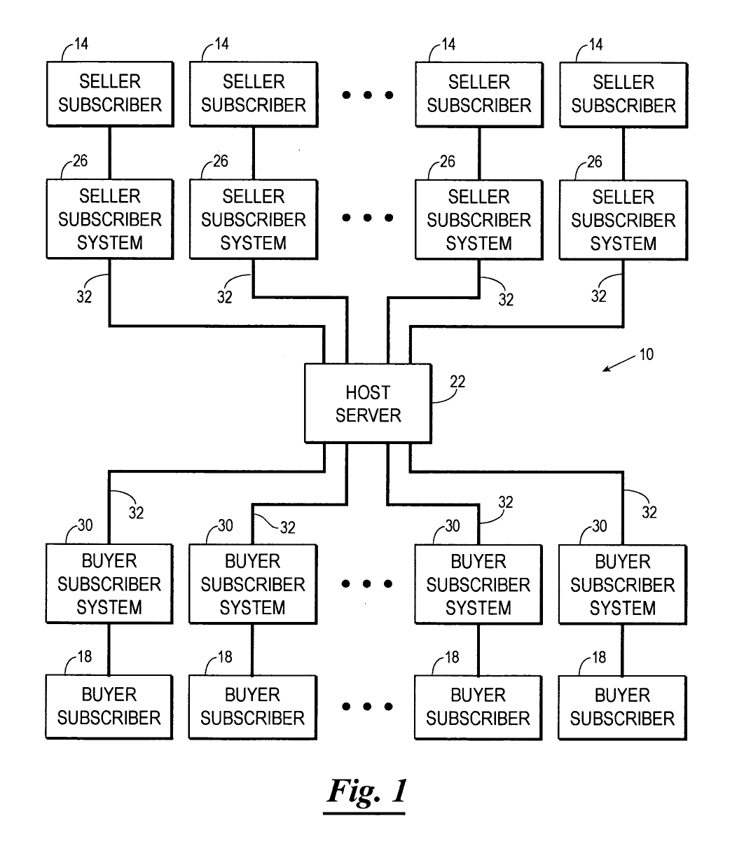

Referring now to the drawings, and in particular to FIG. 1, shown therein and labeled by the reference numeral 10 is an information system constructed in accordance with the present invention. In general, the information system 10 is an information management system which allows a buyer subscriber to negotiate directly with a seller subscriber in an effort to consummate a trade.

Each seller subscriber 14 is an entity who is selling a financial instrument, or who is authorized to represent or act on behalf of a party who is selling a financial instrument; and each buyer subscriber 18 is an entity who is buying or investing in a financial instrument, or who is authorized to represent or act on behalf of a party who is buying or investing in a financial instrument. For example, but not by way of limitation, each seller subscriber 14 and each buyer subscriber 18 can include an individual, a dealer, a broker, a trader, a corporation or business, a government body or agency, a private organization, a sales specialist, a money manager, a financial planner, an insurance company, a commercial bank or other financial institution, a trust company, a pension or mutual fund coordinator, savings and loan, savings bank, credit union, or the like.

The financial instruments identified and transacted in the present invention can be any instrument that can be bought and sold for value. For example, but not by way of limitation, the financial instruments can include fixed income instruments, or variable or floating rate instruments or the like. However, it should be understood that while the present invention is described herein in one preferred embodiment as being utilized for ordering financial instruments, the present invention also contemplates that the information system 10 can be adapted to any item that can be bought and sold. The item can be or relate to any tangible or intangible subject matter. For example, the item can be or relate to an instrument, object, device, good, service, property, document, commercial paper, etc.

The financial instruments identified and transacted in the information system 10 of the present invention can include either or both, foreign and domestic financial instruments. However, domestic financial instruments are preferred so as to eliminate the need for foreign language translations and currency conversions associated with foreign financial instruments.

In one embodiment, the financial instruments identified and transacted in the information system 10 are fixed income instruments. Fixed income instruments are generally securities or certificates of debt issued by a government, corporation, or other entity guaranteeing payment of the original principal investment amount, plus interest, by a specified future date. Such instruments are referred to as “fixed income” because the interest rate or coupon associated therewith is often but not always a fixed rate for a specified period of time. Fixed income instruments include for example, but not by way of limitation, U.S. or foreign treasury bonds, municipal bonds, corporate bonds, mid-term notes, debentures, mortgages, asset-backed securities, collateralized mortgage obligations (CMOs), Certificates of Deposits (CDs), Guaranteed Investment Contracts (GICs), Unit Investment Trusts (UIT) or the like. The general term “bond” is also used herein interchangeably with the term “fixed income instrument.”

In one embodiment, the information system 10 is more specifically adapted for the order and transaction management by a potential buyer and a potential seller relating to domestic corporate and municipal bonds. Also, in one embodiment, the information system 10 is adapted for the ordering of bonds in the secondary market, i.e., after the bond has issued and a first sale of the bond has been transacted. Referring again to FIG. 1, the information system 10 of the present invention includes a host server 22. In general, the host server 22 of the information system 10 is a computer system associated with a third party entity. Preferably, the third party entity is an entity independent of the seller subscribers 14 and the buyer subscribers 18. For example, the third party entity can be a firm, corporation or organization which is not owned or operated by a brokerage entity (one in the business of buying or selling financial instruments), or a consortium of brokerage entities.

The host server 22 is in communication with seller subscriber systems 26 and buyer subscriber systems 30. Each of the seller subscriber systems 26 is a computer system associated with one of the seller subscribers 14. Each seller subscriber 14 utilizes its seller subscriber system 26 to transmit information to and receive information from a buyer subscriber 18 utilizing a buyer subscriber system 30 through the host server 22. Each of the buyer subscriber systems 30 is a computer system associated with one of the buyer subscribers 18. Each buyer subscriber 18 utilizes its buyer subscriber system 30 to transmit information to and receive information from a seller subscriber 14 utilizing one of the seller subscriber systems 26 through the host server 22. The term “transmit,” and derivations thereof, as used herein generally means to send.

The host server 22 includes one or more computer systems (not shown) which are capable of transmitting information to and receiving information from the seller subscriber systems 26 and the buyer subscriber systems 30. For example, the host server 22 can include one or more general computers having a central processor unit (CPU), an I/O unit, and a memory that stores data and various programs such as an operating system and other application programs and software. The host server 22 may also include a communication device for exchanging data (e.g., a satellite receiver, a modem, or network adapter). In one embodiment, to facilitate the storage, management, and searchability of information stored on the host server 22, the host server 22 includes a database and a search engine program. Also, the host server 22 is preferably constructed using Java, XML, and XSL languages and protocols, and a persistent data storage method, such as a relational database.

Each seller subscriber system 26 and each buyer subscriber system 30 includes one or more computer systems (not shown) which are capable of transmitting information to and receiving information from the host server 22. Preferably, each seller subscriber system 26 and each buyer subscriber system 30 includes at least one output device (e.g., a monitor, display, screen, speaker, or printer) and at least one input device (e.g., a keyboard, keypad, mouse, joystick, microphone, or touch-screen). Further, each seller subscriber system 26 and each buyer subscriber system 30 preferably operate a web-browser or other program which allows for the retrieving and viewing of electronic information via the Internet and/or the World Wide Web.

In one embodiment, the host server 22 is established on the Internet so as to be publically available. For example, the host server 22 can include a web server computer system hosting a website on the World Wide Web through which the host server 22 can be accessed using the http protocol (Hypertext Transport Protocol). The seller subscribers 14 and the buyer subscribers 18 can utilize their corresponding seller subscriber systems 26 and buyer subscriber systems 30, respectively, to initiate a web browser and connect to the host server 22 via the website. The establishing of a computer system and websites on the Internet and/or World Wide Web are known to those skilled in the art and therefore no further discussion is deemed necessary to teach one skilled in the art how to establish the host server 22 of the information system 10 on the Internet and/or the World Wide Web.

The host server 22 communicates with the seller subscriber systems 26 and the buyer subscriber systems 30 via communication links 32. The communication links 32 can be any suitable communication link which permits electronic communications, such as such as external (extranet) computer communication systems, internal (intranet) computer communication systems, internal buses, local area networks, wide area networks, Internet networks, point to point shared and dedicated communications, infra red links, microwave links, telephone links, cable TV links, satellite links, radio links, fiber optic links, cable links and/or any other suitable communication device, system or network, or combinations thereof. Preferably, the communication links 32 are Internet based links which allows electronic information to be transferred between the host server 22, the seller subscriber systems 26 and the buyer subscriber systems 30 via the Internet.

Because information security is also important in financial order management applications, the information communicated by the host server 22, the seller subscriber systems 26 and the buyer subscriber systems 30 via the communication links 32 is preferably encrypted or otherwise secured so as to provide secure, reliable, and persistent communication. As such, the seller subscribers 14 and the buyer subscribers 18 can be assured that by using the information system 10, all information is encrypted during transmission and delivery is guaranteed.

In one embodiment, the information system 10 of the present invention utilizes extensible markup language (XML) protocol for importing and exporting information (e.g. inventory and trade data). The use of XML simplifies the integration of the information system 10 with a wide variety of existing systems and allows for the easy interchange of documents via the Internet, and more particularly the World Wide Web. Further, components of the information system 10, such as programs and interfaces (as will be discussed further below), are preferably constructed so as to be readily used with existing hardware and software systems currently in use. For example, the components can be constructed utilizing one or more of extensible markup language (XML), Financial Information eXchange (FIX) protocol, and Java programming language.

In operation, the host server 22 of the information system 10 stores an entity identity for each seller subscriber 14 and for each buyer subscriber 18. The entity identity includes information which identifies the seller subscriber 14 or buyer subscriber 18. For example, the entity identity can be indicative of one or more identity characteristics, including, but not by way of limitation, a contact name, an organization name, an address, a telephone number, a fax number, an email address, a government tax identification number, a Depository Trust Company (DTC) number, or the like. Further, the entity identity can include information indicative of a trading account established between the host server 22 and the seller subscriber 14 or the buyer subscriber 18. For example, the entity identity can include an account number, a predetermined username and a password which the host server 22 associates with the seller subscriber 14 or the buyer subscriber 18. Also, the entity information can include other related information, such as a net capital, a buying power, a selling power and or other industry rating associated with the seller subscriber 14 or the buyer subscriber 18.

The host server 22 also stores a listing for at least one financial instrument being offered for sale by each of the seller subscribers 14. In general, the listing identifies the financial instrument associated therewith by including at least one financial instrument characteristic for the financial instrument being offered for sale by the seller subscriber 14. The financial characteristics included in the listing provide information regarding the offering details or terms of the financial instrument. For example, the listing can include an instrument type for the financial instrument being offered (e.g., municipal bond, corporate bond, etc.), a description or name for the financial instrument, a price per unit for the financial instrument, and a quantity being offered. Additionally, the listing information can include other related information, such as for example an initial, current and/or future value of the financial instrument, an interest rate or coupon for the financial instrument, a coupon type (e.g., fixed rate), an instrument form (e.g., registered), an instrument use (e.g., funding for a transportation project, construction, etc.), an issue date, a maturity or expiration date, a call date, a payment frequency, a yield, a concession, a spread, a benchmark, a credit quality or rating, a tax status (e.g., taxable, exempt, etc.), an issuer identity (e.g., a state name), a standard identification number (e.g., a Committee on Uniform Securities Identification Procedures or CUSIP number), an agency name and relationship for the financial instrument (e.g., a manager, registrar, payment agent or counsel for the financial instrument), a material event for the financial instrument (e.g., a past transfer), and/or an obligation or restriction of the buyer and/or seller.

Further, the host server 22 can allow the seller subscriber 14 to vary the terms of the listing which are disclosed to the buyer subscribers 18. In one embodiment, the host server 22 allows the seller subscriber 14 to specify multiple classes of buyer subscribers 18 based on a defining characteristic (e.g., buying power of the buyer subscribers 18) or by otherwise selecting buyer subscribers 18 to assign to a particular class (e.g., based on an existing account or relationship), and then for each class set a different price for the financial instrument. The buyer subscribers 18 that are in the same class receive the same price for the listing. For example, the seller subscriber 14 may offer to sell a financial instrument to a buyer subscriber having a buying power of less than $25,000 at $100 per unit, while selling to a buyer subscriber 18 having a buying power between $25,000 and $75,000 at $99.75 per unit, and to a buyer subscriber 18 having a buying power of greater than $75,000 at $99.50 per unit.

In one embodiment, at least a portion of the listing for each financial instrument is inputted into the host server 22 by the seller subscriber 14 offering the financial instrument for sale. However, at least a portion of the listing can also be provided by the host server 22. For example, if a price, or yield or spread to a benchmark security is inputted by the seller subscriber 14, the host server 22 can calculate and provide a yield to maturity value for the financial instrument. Also, the terms of the listing can be inputted manually or automatically. For example, the host server 22 can be adapted to receive the terms of the listing which are automatically transmitted by an inventory management system associated with the seller subscriber 14.

Although the host server 22 is described herein in one embodiment as storing the entity identities for seller subscribers 14, the entity identities for the buyer subscribers 18, and the listings identifying the financial instruments being offered by the seller subscribers 14 so as to have access to the entity identities and listings, it should be understood that the present invention contemplates that the entity identities, the listings, or any other information utilized by the host server 22 can be made accessible to the host server 22 in any appropriate manner currently known to those skilled in the art, or later developed. For example, the host server 22 can access such information from a remote computer system or database (not shown).

For each seller subscriber 14, the operation of accessing, inputting a listing, and otherwise utilizing the host server 22 is similar. Therefore, for purposes of clarity, the operation of the host server 22 is described in more detail below for only one seller subscriber 14 and its corresponding seller subscriber system 26.

The seller subscriber 14 logs on to the host server 22 by transmitting a log-in signal utilizing the seller subscriber system 26. In general, the log-in signal is an identifier of the seller subscriber 14, and as such provides information from which the host server 22 can retrieve additional information previously stored for the seller subscriber 14, such as entity identity information for the seller subscriber 14.

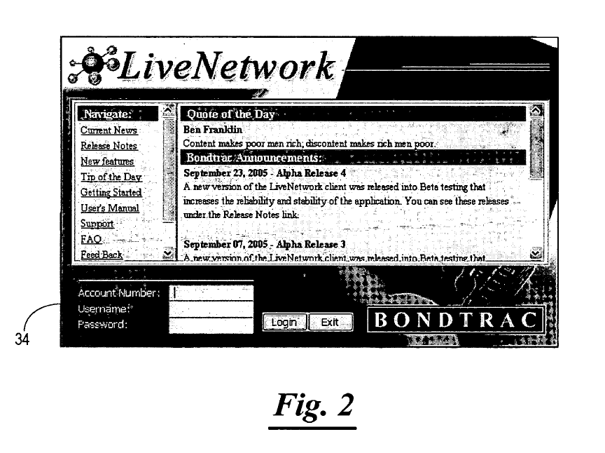

For example, the log-in signal can be transmitted by the seller subscriber 14 inputting an appropriate account number, username and password which identifies the seller subscriber 14 to the host server 22. In one embodiment, to facilitate the input and transmission of the log-in signal, the host server 22 provides a log-in window 34 on the seller subscriber system 26, such as shown for example in FIG. 2. The log-in window 34 allows the seller subscriber 14 to input its account number, username and password, and transmit a log-in signal which includes such information to the host server 22. Once a connection is made between the seller subscriber system 26 and the host server 22, the connection is preferably maintained so as to allow for the real-time receipt and delivery of information (e.g., using XML data).

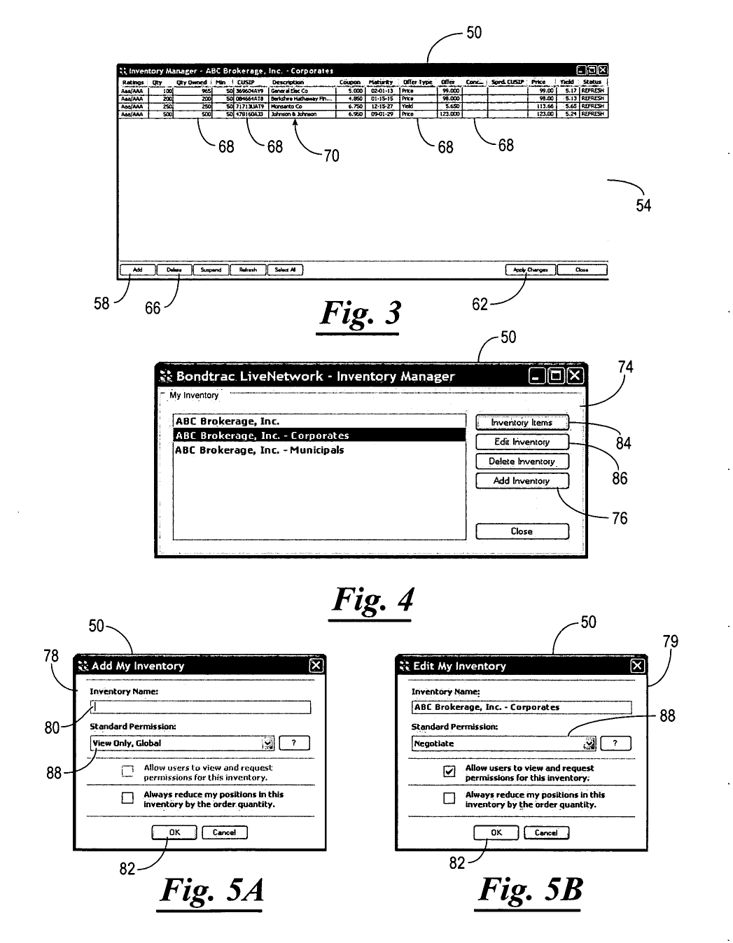

Once the host server 22 receives the log-in signal, the host server 22 provides a seller interface 50 to the seller subscriber 14 via the seller subscriber system 26, such as shown for example in FIGS. 3-5. In general, the seller interface 50 allows the seller subscriber 14 to interact and communicate with the host server 22 so as to input listings, view listings, edit listings, or otherwise utilize the host server 22.

In one embodiment, the seller interface 50 provides an “Inventory Manager” window 54, as shown for example in FIG. 3. In general, the “Inventory Manager” window 54 allows the seller subscriber 14 to input and transmit a listing for one of the financial instruments to the host server 22. The listing received by the host server 22 for the financial instrument can then be utilized by the host server 22 for storing, searching and/or displaying one or more of the offering terms associated with the financial instrument. Further, the “Inventory Manager” window 54 allows the seller subscriber 14 to edit or change a listing stored on the host server 22, or to delete or remove the listing (such as when the financial instrument identified by the listing has been sold or is no longer for sale).

To facilitate the input of the listing, the “Inventory Manager” window 54 includes an input means having one or more entry fields or predetermined selectable inputs in the form of entries in a pull down menu bar, radio buttons, push buttons, linked text or images, or the like. For example, as shown in FIG. 3, the “Inventory Manager” window 54 in one embodiment includes an “Add” button 58, an “Apply Changes” button 62, and a “Delete” button 66. When the seller subscriber 14 pushes the “Add” button 58, entry fields 68 are provided in a listing archive 70 in the “Inventory Manager” window 54. In the entry fields 68, the seller subscriber 14 inputs information for one or more predetermined terms of the listing, such as the quantity, CUSIP, type or description, coupon, maturity date, price, yield, concession, spread, etc. After all the desired inputs are entered, the seller subscriber 14 presses the “Apply Changes” button 62 to save the listing.

When the seller subscriber 14 wants to edit an existing listing, the seller subscriber 14 can highlight or otherwise select the listing from the listing archive 70, make changes within the entry fields and push the “Apply Changes” button 62, and the host server 22 will save the changed listing. When the seller subscriber 14 wants to delete one of the listings, the seller subscriber 14 can highlight or otherwise select the listing from the listing archive 70 and push the “Delete” button 66, and the host server 22 will delete the listing. Also, the seller subscriber 14 can “suspend” or “refresh” inventory listings.

While the “Inventory Manager” window 54 generally includes currently active listings in the listing archive 70, it should be understood that the “Inventory Manager” window 54 can also store and display past listings, such as edited, deleted or closed listings which were posted on the host server 22 by the seller subscriber 14.

In one embodiment, the seller interface 50 further allows the seller subscriber 14 to manage multiple groups of listings, i.e., multiple inventories. The seller interface 50 allows the seller subscriber 14 to assign one or more listings to an inventory group. The inventory group can be identified by a title or number given to the inventory group by the seller subscriber 14 or the host server 22. In one embodiment, the seller interface 50 provides a My Inventory window 74, such as shown for example in FIG. 4, to facilitate the creation and function of the inventory groups. The “My Inventory” window 74 includes an “Add Inventory” button 76 which initiates an “Add My Inventory” subwindow 78, such as shown for example in FIG. 5A. In the “Add My Inventory” subwindow 78, the seller subscriber 14 defines a title for a new inventory group in an “Inventory Name” entry field 80, and presses an “OK” button 82 to save the inventory group.

Once one or more inventory groups are created, they can be displayed in the “My Inventory” window 74, such as shown for example in FIG. 4. The seller subscriber 14 can then highlight or otherwise select one of the inventory groups for which the seller subscriber 14 wants to open the “Inventory Manager” window 54 so that the seller subscriber 14 can add, review, edit, and/or remove a listing, as described above. In one embodiment, the “My Inventory” window 74 includes an “Inventory Items” button 84 which initiates the “Inventory Manager” window 54 for the selected inventory group.

To allow the seller subscriber 14 to edit one of the inventory groups, the “My Inventory” window 74 further includes an “Edit Inventory” button 86. Once the seller subscriber 14 highlights or otherwise selects one of the inventory groups the seller subscriber 14 wants to edit, the seller subscriber 14 pushes the “Edit Inventory” button 86, which initiates the “Edit My Inventory” window 79 in a manner similar to the “Add Inventory” button 76. The seller subscriber 14 can then edit the title of an existing inventory group in a similar manner as that discussed above for inputting the title for a new inventory group.

In one embodiment, the seller interface 50 (shown in FIG. 5B) further allows the seller subscriber to define a user permission for each inventory group, which is then categorically applied to the listings in that inventory group. In general, the user permission indicates to the host server 22 how the listings in the inventory group are to be disclosed to the buyer subscribers 18. For example, as shown in FIG. 5A, the “Add My Inventory” window 78 can allow the seller subscriber 14 to define a user permission for the inventory group in a “Standard Permission” input means 88. In one embodiment, the user permissions are predetermined and, as shown best in FIG. 5B, are provided as selectable entries in a pull-down menu bar. The predetermined user permissions included in the “Standard Permission” input means 88 are a (1) “restricted” setting, (2) a “view only” setting, (3) a “trade at list” setting, and (4) a “negotiate” setting.

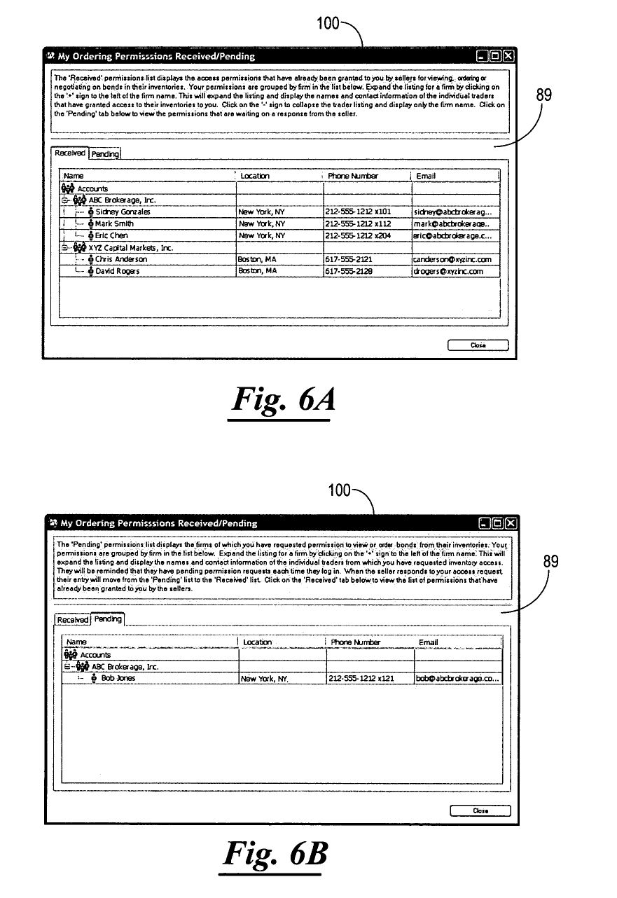

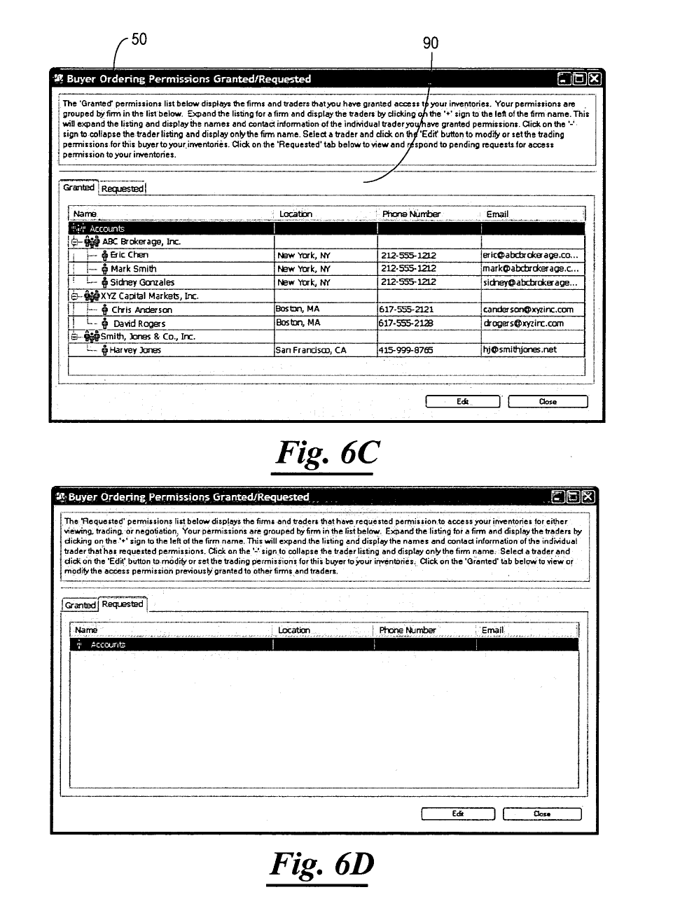

The “restricted setting” indicates that the listings in the inventory group should not be shown to any buyer subscriber 18 unless the buyer subscriber 18 has an established viewing permission from the seller subscriber 14. In one embodiment, the buyer subscribers 18 which have established viewing permission from the seller subscriber 14 are displayed in a “Buyer Ordering Permissions Granted” window 90, as shown for example in FIG. 6C. The seller interface 50 also preferably includes a “Buyer Ordering Permissions Requested” window 91 (FIG. 6D) displaying any pending requests for viewing permission that are waiting approval or rejection. The “view only” setting indicates that the listings in the inventory group can be disclosed to the buyer subscribers 18, but that an electronic order cannot be placed.

The “trade at list” setting indicates that the listings in the seller subscriber's inventory group will be disclosed only to those buyer subscribers permitted to view such list by the seller subscriber, and that an electronic order can be placed by a buyer subscriber at the terms (e.g., price) as defined in the listing. This user permission setting is used, for example, when the seller subscriber 14 intends that the listing be executable. The term “executable” as used herein generally refers to offerings, the sales price for which has been pre-approved by the seller, and that can be instantaneously accepted by a buyer subscriber having trading permission without the need of an additional manual approval from the seller subscriber 14. For example, an executable offering can be provided through a real-time, automated executable data feed from the seller subscriber rather than requiring a live trader. Generally executable offerings are only available during specified trading hours, and are not negotiable since a live trader is not servicing the offering.

The “negotiate” setting indicates that the listings in the inventory group will be disclosed to all permissional buyer subscribers, and that the buyer subscriber 18 can enter into negotiations with the seller subscriber 14 on the terms of the listing. These buyer ordering permission settings are used for example when the seller subscriber 14 intends the listing to be negotiable. The term “negotiable” as used herein generally refers to offerings of a seller subscriber that has a live trader associated therewith that is available for real-time communication, negotiation, and confirmation of orders with a buyer subscriber.

As such, it can be seen that the information system 10 of the present invention allows a seller subscriber to provide executable offerings to a buyer subscriber. Thus, the information system 10 consolidates all types of offerings so as to provide the broadest spectrum of available offerings. Further, it should be understood that the status of an offering listed in the information system 10 can be changed depending on the time of day or whether the offering seller subscriber is present so as to provide flexibility for the seller subscribers 14.

The seller interface 50 is described as allowing the seller subscriber 14 to define a user permission for each of the inventory groups so that the user permission is categorically applied to the listings in the inventory group.

For each buyer subscriber 18, the operation of accessing, searching, and otherwise utilizing the host server 22 of the information system 10 is similar. Therefore, for purposes of clarity, the operation of the host server 22 is described in more detail below for only one buyer subscriber 18 and its corresponding buyer subscriber system 30.

The buyer subscriber 18 logs on to the host server 22 by transmitting a log-in signal utilizing the buyer subscriber system 30. In general, the log-in signal is an identifier of the buyer subscriber 18, and as such provides information from which the host server 22 can retrieve additional information previously stored for the buyer subscriber 18, such as entity identity information for the buyer subscriber 18.

For example, the log-in signal can be transmitted by the buyer subscriber 18 inputting an appropriate account number, username and password which identifies the buyer subscriber 18 to the host server 22. In one embodiment, the host server 22 provides the log-in window 34 (see FIG. 2) to the buyer subscriber 18 via the buyer subscriber system 30. In a similar manner as described above for the seller subscriber 14, the log-in window 34 provided to the buyer subscriber system 30 allows the buyer subscriber 18 to input its account number, username and password, and transmit a log-in signal which includes such information to the host server 22. Once a connection is made between the buyer subscriber system 30 and the host server 22, the connection is preferably maintained so as to allow for the real-time receipt and delivery of information (e.g., using XML data). The term “real-time” as used herein generally relates to the characteristic associated with computer systems that update information at the same rate as they receive data, or within a short amount of time of receiving data, so as to enable them to direct or control a process or display information without a significant or perceptible delay.

Once the host server 22 receives the log-in signal from the buyer subscriber 18, the host server 22 provides a buyer interface 100 (FIG. 7) on the buyer subscriber system 30, as shown for example in FIGS. 7-19. In general, the buyer interface 100 allows the buyer subscriber 18 to interact and communicate directly with a seller subscriber through the host server 22 to view listings provided by such seller subscriber. In one embodiment, the buyer interface 100 and the seller interface 50 are incorporated into one user interface for a subscriber when the subscriber of the information system 10 is both a buyer subscriber and a seller subscriber. However, for purposes of clarity and discussion, the buyer interface 100 and the seller interface 50 are generally described herein as separate components.

Once the buyer subscriber 18 is logged onto the server 22, the buyer subscriber 18 can transmit a request or an information code of data to the host server 22 via the buyer subscriber system 30 which indicates a selection of one of the listings stored by the host server 22. Then, as discussed further below, upon selection by the buyer subscriber of a particular listing from a seller subscriber, the host server 22 connects the buyer subscriber system 30 to the seller subscriber system 26 associated with the seller subscriber 14 offering. Once connected the buyer subscriber 18 and the seller subscriber 14 can communicate directly with each other via the host server 22.

In one embodiment, to aid the buyer subscriber 18 in locating and selecting at least one listing of interest, the buyer subscriber 18 transmits a search request to the host server 22. In general, the search request includes information which identifies at least one of the listings stored by the host server 22. For example, the search request can identify an instrument type (e.g., municipal bond, corporate bond, etc.), a description or name, a price (or price range) per unit, or a quantity (or quantity range) for a financial instrument which the buyer subscriber 18 is interested in buying. Additionally, the search request can include one or more other related characteristics, such as for example an initial, current par value (or value range), an interest rate or coupon (or coupon range), a maturity or expiration date (or time frame), a yield (or yield range), a spread, a benchmark, an issuer identity, a seller entity identity, a standard identification number (e.g., a CUSIP number), an agency name and relationship for the financial instrument, an obligation, or restriction of the buyer and/or seller, or a user permission status (e.g., executable, negotiable, or confirmable). Further, the search request can include characteristics relating to the date and/or time the listing was posted, or whether any portion of the listing has changed (e.g., a price or quantity change), payment frequency, payment month, use of proceeds, industry, tax status, bond form (registered, bearer book entry) or the like. After obtaining a response to the search request, the buyer subscriber then has the discretion to contact a seller subscriber having an offering available which meets the requirements of the search request.

In one embodiment, to facilitate the input and transmission of the search request, the buyer interface 100 provides a “Quick Search” means 101, such as shown for example in FIG. 7. In the “Quick Search” means 101, at least one parameter of the search request can be inputted by the buyer subscriber 18. Preferably, the number of parameters that can be inputted using the “Quick Search” means 101 is limited so that a quick, cursory search can be performed. As such, the “Quick Search” means 101 would typically be used when a generally unique offering term is known for the listing that the buyer subscriber 18 wants to locate, such as for example the CUSIP number, the description, issuer, or ticker symbol for the issuing company, or state code. In one embodiment, as shown for example in FIG. 7, the “Quick Search” means 101 includes an entry field 102 and predetermined selectable inputs in the form of entries in a pull down menu bar 103. The selected entry in the pull down menu bar 103 specifies which parameter is being defined by the input provided in the entry field 102, i.e., CUSIP, state, ticker symbol, issuer name or dealer name.

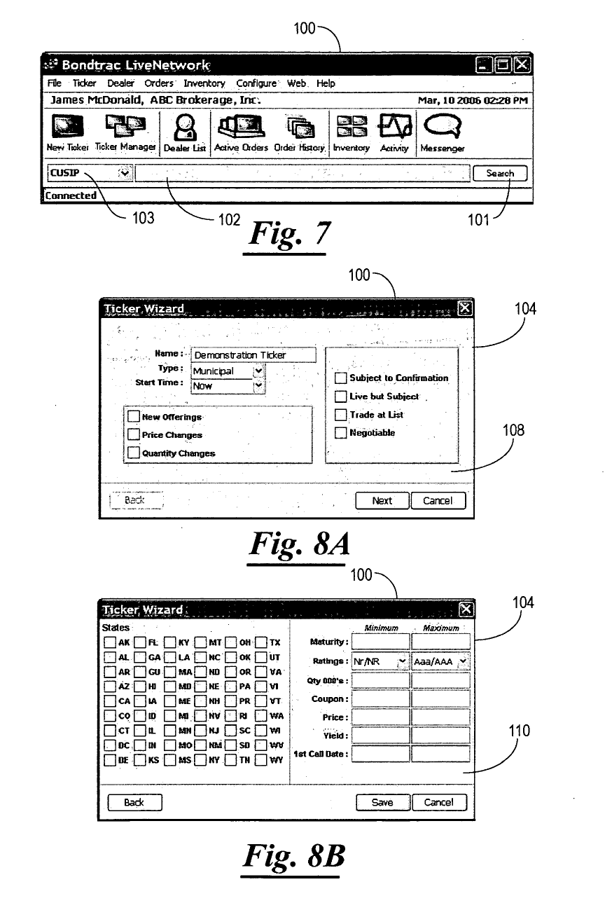

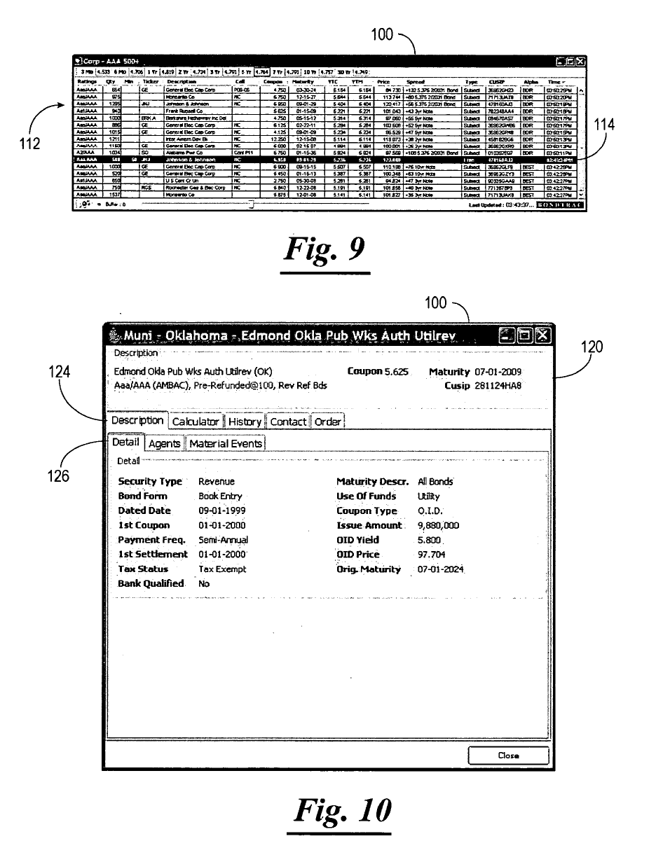

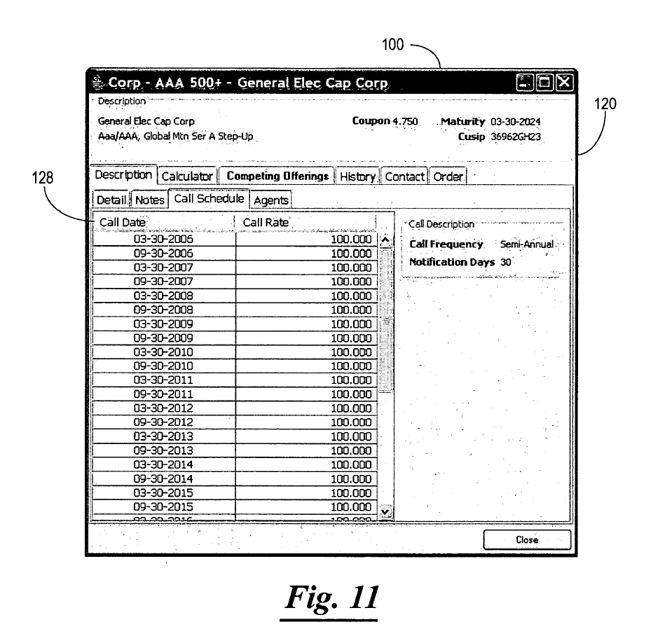

In another embodiment, to facilitate the input and transmission of the search request, the buyer interface 100 provides a “Ticker Wizard” window 104, as shown for example in FIGS. 8A-8B. In general, the “Ticker Wizard” window 104 is a search window wherein the buyer subscriber 18 can input and transmit the search request to the host server 22. The “Ticker Wizard” window 104 includes an input means having one or more entry fields or predetermined selectable inputs in the form of entries in a pull down menu, radio buttons, push buttons, linked text or image, or the like, wherein input can be provided relating to the parameters that the buyer subscriber 18 wants to include in the search request.

Also, the input means of the “Ticker Wizard” window 104 can be arranged in series so that the buyer subscriber 18 can narrow the searchable field and be directed to more relevant search terms. In one embodiment, the “Ticker Wizard” window 104 includes a first screen 108, such as shown for example in FIG. 8A, and a second screen 110. In the first screen 108, the buyer subscriber 18 can input the type of financial instrument (e.g., municipal or taxable) for the search request, a scan time for how far back in time to search for active listings (e.g., now and time forward, 1 hour back and time forward, or no time limit), and/or whether the listing is new, has a price change, or a quantity change. The first screen 108 can also include a “Name” entry field wherein the buyer subscriber 18 can enter a title for the search request.

In the second screen 110, the buyer subscriber 18 can define more parameters for the search request. For example, as shown in FIG. 8B, when a municipal financial instrument is indicated in the first screen 108, the second screen 110 allows the buyer subscriber 18 to define other parameters such as for example, a state of issuance and a range for the maturity, rating, quantity, coupon rate, offering price, yield, or first call date.

The information within the search request is used by the host server 22 to search through the listings stored on the host server 22 to locate at least one listing which has at least one financial instrument characteristic identified by the search request. The host server 22 can search for the listings that correspond to or includes all the characteristics defined by the search request, or the host server 22 can search for the listings which match substantially or within a threshold value (as set by the host server 22 or the buyer subscriber 18). If no searched for listing exists, the host server 22 can indicate to the buyer subscriber 18 that a new search request should be submitted.

Further, the host server 22 can evaluate listings based on the user permission or the desired buyer qualification associated with each listing and the corresponding entity information associated with the buyer subscriber 18. As such, the listings for which the buyer subscriber 18 does not meet the user permission restrictions or desired buyer qualification, will not be retrieved and displayed by the host server 22.

Once at least one listing is identified by the host server 22, the host server 22 generates and transmits to the buyer subscriber 18 a search result containing at least a portion of the listing. The search result also contains the entity identity of the seller subscriber offering to sell the financial instrument identified by the listing. By transmitting the entity identity (e.g., the name and contact information) of the seller subscriber 14 to the buyer subscriber 18, the identity of the seller subscriber 14 is fully disclosed to the buyer subscriber 18, and allows the buyer subscriber 18 to be fully aware of who will be involved in the transaction should the buyer subscriber 18 desire to proceed to negotiate and/or finalize a purchase of the financial instrument identified by the listing.

In one embodiment, to facilitate the initial display of information of the search result, the buyer interface 100 provides a portion of the listing and entity identity for each listing in a ticker list 112, such as shown for example in FIG. 9. For example, the ticker list 112 can include the name of seller subscriber 14 associated with the financial instrument identified by the listing, and one or more offering details for the listing (e.g., the ratings, quantity, instrument type, coupon, maturity, yield to call, yield to maturity, price, or spread). The portion of the listing and entity identity displayed in the ticker list 112 can be determined by the host server 22 or set by the buyer subscriber 18. From this initial display, the buyer subscriber 18 can then select and indicate to the host server 22 one of the listings in the ticker list 112 which the buyer subscriber 18 wants to further evaluate (i.e., receive more information for, perform analytics on, negotiate a price for, and/or place an order for).

The search request can be stored by the host server 22 so that the host server 22 can provide a real-time scanning search by continuously or periodically repeating the search, and then automatically updating or forwarding the search results to the buyer subscriber 18 when a listing matching the request is received from one of the seller subscribers 14 and stored by the host server 22. Additionally, the search request can be stored on the host server 22 and then resubmitted upon demand of the buyer subscriber 18. For example, the search request can be stored by the host server 22 under an identifying name, which can be used by the buyer subscriber 18 to locate and resubmit the search request, and/or edit or delete the search request. Further, it should be understood that multiple search requests can be submitted by a buyer subscriber at any given time.

Preferably, the ticker list 112 displaying at least a portion of the search result to the buyer subscriber 18 is continually or periodically updated as new listings are stored on the host server 22 so as to provide more real-time information as new listings enter the market. As long as the buyer subscriber 18 is logged onto the host server 22, the updated listing information will stream into the ticker list 112. Additionally, the ticker list 112 can be updated upon demand of the buyer subscriber 18.

In one embodiment, the host server 22 further provides a presence indicator 114 in the ticker list 112 which indicates to the buyer subscriber 18 when the seller subscriber 14 associated with one of the listings is logged onto the host server 22. In one embodiment, the presence indicator 114 includes at least one of highlighting, bolding, coloration, and a symbol. For example, the host server 22 can highlight one of the listings, provide the listing in a different color or sized text, and/or provide a symbol near the listing in the ticker list 112 when the seller subscriber 14 offering the financial instrument identified by the listing is logged onto the host server 22. When the seller subscriber 14 terminates the connection between the seller subscriber system 26 and the host server 22 by logging off, the host server 22 removes the presence indicator 114. Further, the host server 22 can monitor action or inaction of transmissions from the seller subscriber system 26 to determine whether the presence indicator 114 should be provided. Also, the host server 22 can allow each of the seller subscribers 14 logged onto the system to request that the presence indicator 114 not be shown for one or more of the listings associated with the seller subscriber 14 at any given time, and remain as such for a duration of time or until a predetermined trigger. For example, one of the seller subscribers 14 can indicate to the server 22 to remove the presence indicator 114 for one or more of its listings so as to temporarily suspend the listing during a market moving event or while the listing is being edited. As another example, the seller subscriber 14 can indicate to the server 22 to remove the presence indicator 114 while the seller subscriber 14 is away from the trading desk temporarily. The seller subscriber 14 can then indicate to the server 22 to again provide the presence indicator 114, e.g., by sending a presence signal via the seller interface 50.

Generally, the presence indicator 114 is only provided for listings in the search result which have been indicated as negotiable by the seller subscriber 14. However, the listings in the search result which are executable or subject to confirmation can similarly be indicated as such in the ticker list 112 by providing a visual cue such as a unique highlight color, text color or bolding, and/or symbol. Other factors or information which the buyer subscriber 18 would want to be alerted to can also be utilized to determine when such visual cues are used for one of the listings, such as for example when the price, quantity or yield of the listing has changed, or when a yield exceeds a threshold value (e.g., is greater than 5.0).

As discussed above, from the initial display of the search result in the ticker list 112, the buyer subscriber 18 can select and indicate to the host server 22 one of the listings in the ticker list 112 which the buyer subscriber 18 wants to further evaluate. In one embodiment, once the buyer subscriber 18 selects one of the listings in the ticker list 112, the buyer interface 100 provides a “Listing” window 120 for the listing, such as shown for example in FIGS. 10-19. In general, the “Listing” window 120 displays the listing and entity identity (or a portions thereof) in further detail. The “Listing” window 120 also provides other tools and messaging functions which allow the buyer subscriber 18 to evaluate the listing.

In one embodiment, the “Listing” window 120 displays at least a portion of the listing in a “Description” screen 124, such as shown for example in FIGS. 10-14. Preferably, the “Description” screen 124 includes multiple sub-screens so as to present the information in a more organized fashion. For example, as shown in FIG. 10, the “Description” screen 124 in one embodiment includes a “Detail” sub-screen 126 which displays the issuer identity, the coupon rate and type, the maturity date, the CUSIP, the ratings and insurance (if any), the instrument type, form and use, the tax status, the yield, the price, and various dates of interest for the financial instrument. In a “Call Schedule” sub-screen 128, the details of a call schedule, such as future call dates and rates are displayed, as shown for example in FIG. 11. Other information for the call options can also be included in the “Call Schedule” sub-screen 128, such as other legal characteristics and call frequencies (in whole or in part).

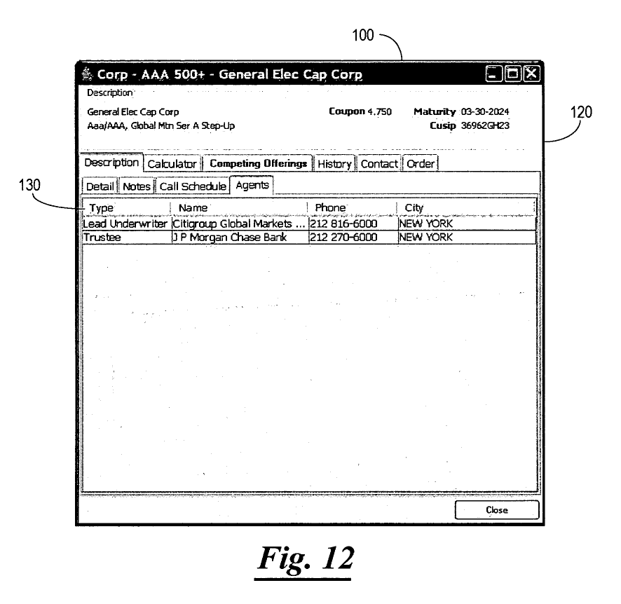

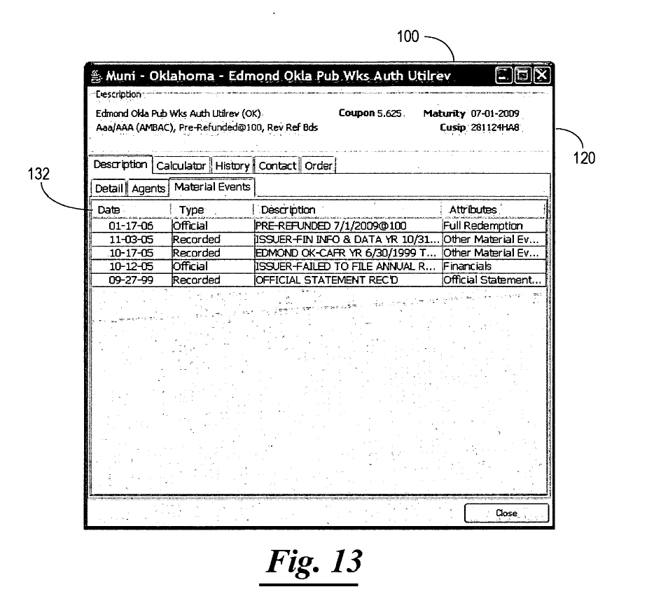

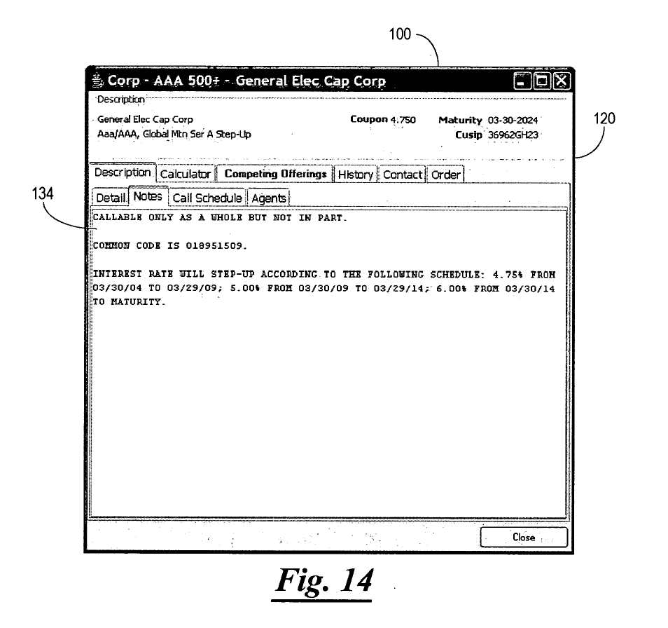

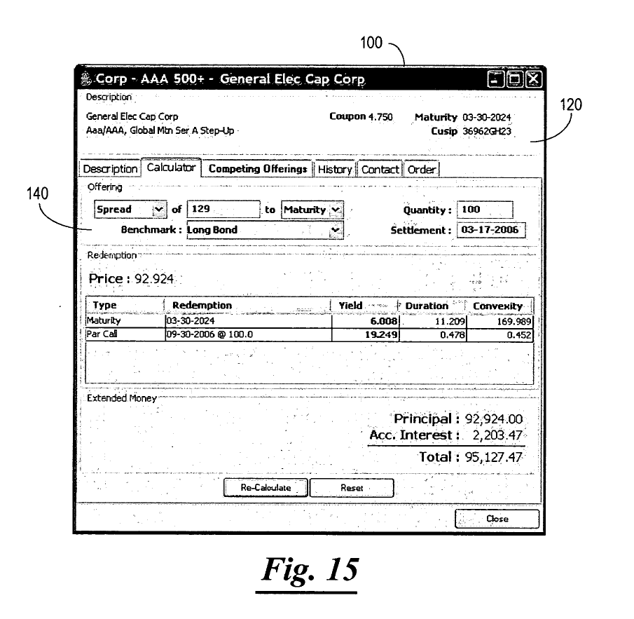

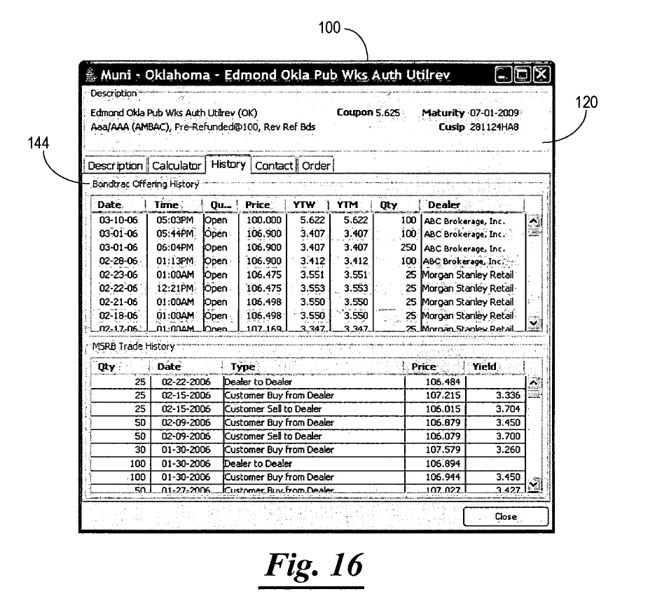

In an “Agents” sub-screen 130 of the “Listing” window 120, a list of firms and the agent capacity in which they perform for the financial instrument are displayed, as shown for example in FIG. 12. In a “Material Events” sub-screen 132, material events (e.g., financial statements released, announcement of calls) are displayed, as shown for example in FIG. 13. Further, a “Notes” sub-screen 134 is provided to include additional information explaining details of the terms and conditions of the offering, such as for example buyer and seller obligations or restrictions, as shown for example in FIG. 14.

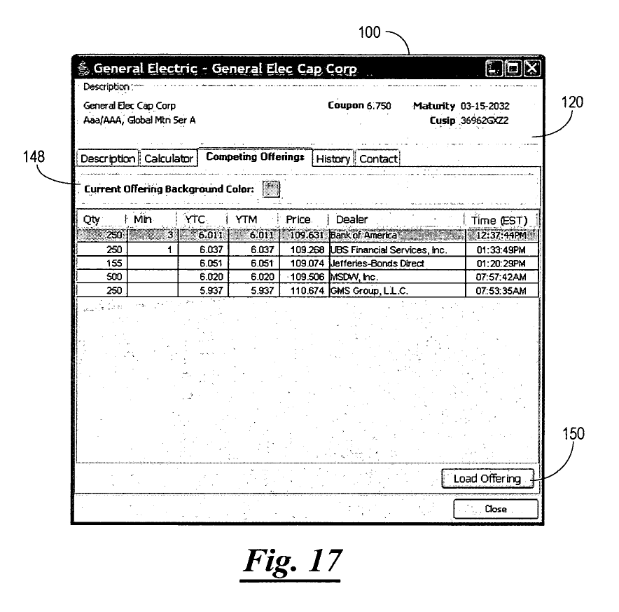

In one embodiment, the “Listing” window 120 further provides other analytical tools or products which the buyer subscriber 18 can utilize to evaluate the financial instrument. For example, shown in FIG. 15 is a “Calculator” screen 140, wherein the “Listing” window 120 provides a price-yield calculator. The “calculator” screen 140 allows the buyer subscriber 18 to define variables and calculate values of interest, such as for example net price, yields to maturity and calls, and extended monies. The “Listing” window 120 can also include other tools, such as for example a dynamic yield curve graph (not shown).

In one embodiment, the “Listing” window 120 also includes a “History” screen 144, such as shown for example in FIG. 16. The “History” screen 144 includes an offering history for the financial instrument (e.g., as identified by the CUSIP number) which details any past offerings of the financial instrument by the same or other seller subscribers 14. Preferably, the offering history is summarized wherein only a portion of the past listings are displayed (e.g., the price, yields, quantity, and contact name). Also, the host server 22 can provide other information relating to those past listings, such as when the listing was posted, whether the listing is an open price, or whether the listing is a high or low price or closing price for the seller subscriber 14 associated therewith. The “History” screen 144 also shows a trade history for the financial instrument (e.g. based on a CUSIP). The trade history can include information relating to when trades for the financial instrument have taken place in the market in the past, and at what price and quantity.

Further, the “Listing” window 120 in one embodiment includes a “Competing Offerings” screen 148, such as shown for example in FIG. 17. The “Competing Offerings” screen 148 displays listings for the same or a similar financial instrument (e.g., those that have the same CUSIP) which are currently being offered by other seller subscribers 14 so as to allow the buyer subscriber 18 to compare competing offerings. In one embodiment, the “Competing Offerings” screen 148 further allows the buyer subscriber 18 to switch to a selected competing listing by pressing a “Load Offering” button 150 provided in the “Competing Offerings” screen 148. Such action indicates to the host server 22 that the selected competing listing (and the entity identity of the seller subscriber offering that listing) should now be displayed in the “Listing” window 120.

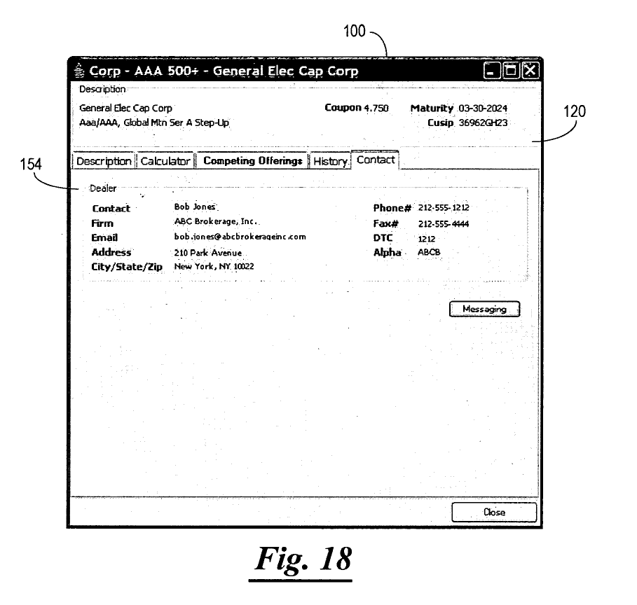

In addition to displaying at least a portion of the listing in more detail, the “Listing” window 120 preferably displays at least a portion of the entity identity of the seller subscriber 14 offering the listing. In one embodiment, the “Listing” window 120 displays at least a portion of the entity identity of the seller subscriber 14 associated with the listing in a “Contact” screen 154, such as shown for example in FIG. 18. The “Contact” screen 154 includes for example the seller subscriber's contact name, organization name, email, address, phone number, fax number, and DTC number.

In one embodiment, the buyer interface 100 further allows the buyer subscriber 18 to update or refresh the listing being displayed in the “Listing” window 120 so as to obtain any new or changed information in the listing. Preferably, the host server 22 alerts the buyer subscriber 18 when the listing being displayed has been edited so that the buyer subscriber 18 can choose to update the “Listing” window 120, and have the new or changed information displayed in the “Listing” window 120.

Also, the host server 22 can monitor when the buyer subscriber 18 selects one of the listings from the ticker list 112 to evaluate in the “Listing” window 120. In one embodiment, this monitored activity is recorded in a viewed history, and preferably includes at least a portion of the entity identity of the buyer subscriber 18 (e.g., the name and contact information for the buyer subscriber 18) and the date and time the selection was made and viewed. The viewed history can then be transmitted by the host server 18 to the seller subscriber 14 associated with the listing so that the seller subscriber 14 has information indicative of who has viewed the listing. For example, the viewed history can be displayed in a window in the seller interface 50, and/or be linked to the listing archive 70 of the seller interface 50. If desired, the seller subscriber 14 can then utilize the viewed history to contact a buyer subscriber 18 that has viewed the listing so as to target a buyer subscriber 18 that presumably had some interest in the financial instrument identified by the listing.

Once the buyer subscriber 18 has found a listing for a financial instrument the buyer subscriber 18 is interested in, the buyer subscriber 18 can transmit an order request to the seller subscriber 18. For example, the request can be indicative of a bid for the financial instrument by the buyer subscriber 18, which can include a price and/or quantity that the buyer subscriber 18 is willing to purchase. Alternatively, the request can be indicative of a final bid or order by the buyer subscriber 18. Further, the order request can include a proposed term or question regarding the financial instrument. For example, the request can include the statement “Even though you are asking $99.75, will you take $99.50 for this financial instrument.”

If the seller subscriber 14 offering to sell the financial instrument identified by the listing is logged-on (i.e., has transmitted a log-in signal to the host server 22 as described above), the host server 22 transmits the request received from the buyer subscriber 18 to the seller subscriber 14. Preferably, the host server 22 also transmits at least a portion of the entity identity identifying the buyer subscriber 18. By transmitting at least a portion of the entity identity of the buyer subscriber 18 to the seller subscriber 14, the identity of the buyer subscriber 18 is more fully disclosed to the seller subscriber 14, and allows the seller subscriber 14 to be more fully aware of who will be involved in the transaction should the seller subscriber 14 desire to proceed to negotiate and finalize a sale of the financial instrument.

Once the seller subscriber 14 receives the order request, the seller subscriber 14 can transmit to the buyer subscriber a response which includes information relating to the order request by the buyer subscriber 18. Generally, the response is sent by the seller subscriber 14 in response to the order request from the buyer subscriber 18. In other words, the seller subscriber 14 evaluates the order-request and responds accordingly in the response. For example, if a bid or order from the buyer subscriber 18 is desirable because of an existing relationship, or the desire to create a relationship, the order response from the seller subscriber 14 can be indicative of an acceptance of the bid or order made by the buyer subscriber 18. Alternatively, the response from the seller subscriber 14 can be indicative of a rejection of a bid or order by the buyer subscriber 18. Further, the response can include a counter offer or negotiations regarding the financial instrument. For example, the response can include the statement “I will not take less than $99.75 for this financial instrument.”

Although the order response sent by the seller subscriber 14 to the buyer subscriber 18 is described above as generally being in response to an order request being sent from the buyer subscriber 18, in one embodiment the host server 22 allows the seller subscriber 14 to communicate with a buyer subscriber at any time. For example, as discussed above, the host server 22 can generate and transmit the viewed history to the seller subscriber 14 which details when one of the buyer subscribers 18 has selected one of the listings from the ticker list 112 for further evaluation. The host server 22 can further allow the seller subscriber 14 to select and indicate one of the buyer subscribers 18 in the viewed history with whom the seller subscriber 14 wants to communicate. This would allow the seller subscriber 14 to communicate with the buyer subscriber 18 and/or initiate negotiations for the financial instrument identified by the listing, thereby targeting a buyer subscriber 18 that presumably had an interest in purchasing the financial instrument. For example, the response can include the statement “If I lowered the price to $99.50, would you be interested in purchasing this financial instrument,” or the statement “The price for this financial instrument has been lowered to $99.50, please see the updated listing to place an order if you are still interested.”

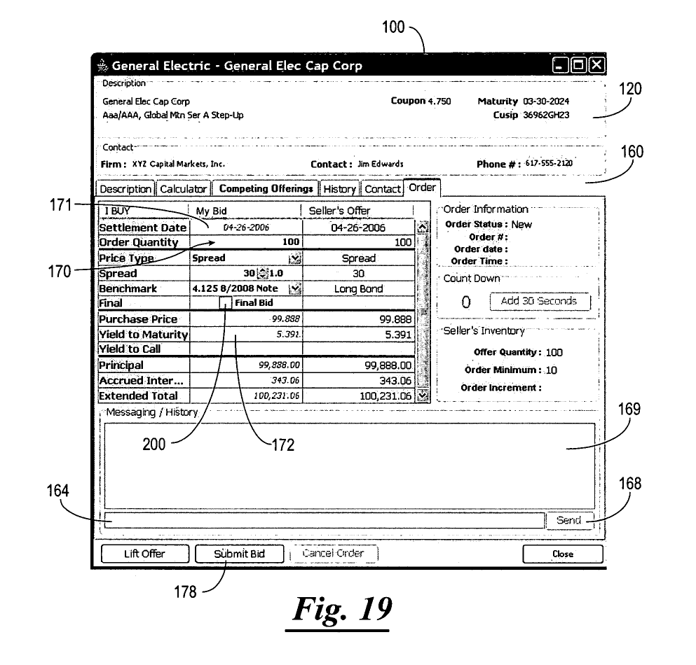

In one embodiment, to facilitate the input and transmission of the order requests by the buyer subscriber 18, the “Listing” window 120 of the buyer interface 100 further includes an “Order” screen 160, such as shown for example in FIG. 19. The “Order” screen 160 includes a “Comment” field 164 wherein the buyer subscriber 18 inputs an order request, and a “Send” button 168 which causes the transmission of the order request to the host system 22. Also, the “Order” screen 160 can include price limits wherein parameters typically associated with a bid can be readily inputted into an order request by the buyer subscriber 18. For example, as shown in FIG. 19, the “Order” screen 160 can include a “Quantity” entry field 170 wherein a quantity can be inputted, a “Settlement” entry field 171 wherein a settlement date can be inputted, and a “Bid yield to maturity” entry field 172 wherein a bid price can be inputted and calculated in terms of the yield to maturity. Also, for the buyer subscriber's reference, the price in terms of dollars, as well as other factors such as the principal, accrued interest, and total, can be automatically determined by the host server 22 and displayed to the buyer subscriber 18. Once the desired bid terms are inputted, the buyer subscriber 18 can push a “Submit Bid” button 178 in the “Order” screen 160 to have the order request containing the bid terms transmitted to the seller subscriber 14.

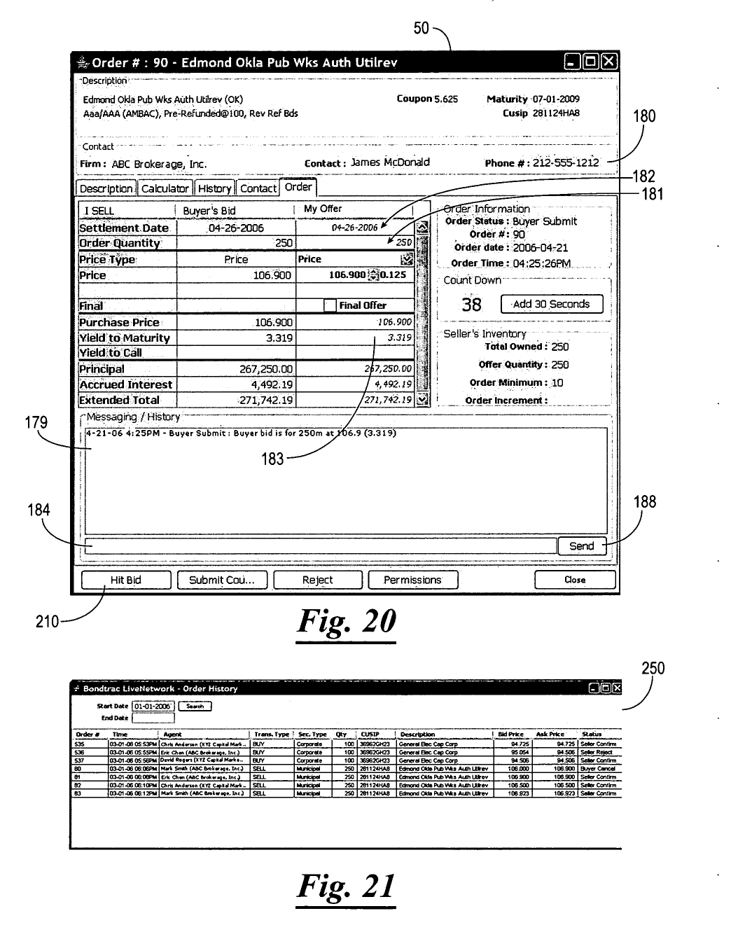

In one embodiment, when the request is transmitted to the seller subscriber system 26, an “Order” screen 180 is displayed to the seller subscriber 14 via the seller interface 50, such as shown for example in FIG. 20. The “Order” screen 180 is similar in construction to the “Order” screen 160 discussed above for the buyer interface 100. When the order request is transmitted by the buyer subscriber 18 via the “Comment” box 164 and “Send” button 168 of the buyer interface 100 by the buyer subscriber 18, the order request is displayed to the seller subscriber 14 in a “Bond Offering History” box 179 in the “Order” screen 180 of the seller interface 50. Similarly, the order request can also be displayed in a “Messaging/History” box 169 in the buyer interface 100 (see FIG. 19). When the order request is transmitted by the buyer subscriber 18 via the price limits and the “Submit Bid” button 178 of the buyer interface 100, the bid terms included in the order request are automatically displayed in corresponding fields in the “Order” screen 180 of the seller interface 50, such as in a “Quantity” entry field 181, a “Settlement” entry field 182, and a “Bid yield to maturity” entry field 183. Also, for the seller subscriber's reference, the price in terms of dollars, as well as other factors such as the principal, accrued interest, and total, can be automatically determined by the host server 22 and displayed to the seller subscriber 14.

To facilitate the input and transmission of the order responses by the seller subscriber 14, the “Order” screen 180 of the seller interface 50 includes a “Comment” field 184 wherein the seller subscriber 14 inputs the order response, and a “Send” button 188 which causes the transmission of the response to the host system 22. The host system 22 then transmits the response to the buyer subscriber system 30 so that the response can be displayed to the buyer subscriber 18. In one embodiment, the request is displayed to the buyer subscriber 18 in the “Messaging/History” box 169 of the buyer interface 100 (see FIG. 19). Similarly, the response can also be displayed in the “Messaging/History” box 179 of the seller interface 50 (see FIG. 20)

The order requests transmitted by the buyer subscriber 18 and the order responses transmitted by the seller subscriber 14 can be exchanged back and forth, preferably in real-time, by the seller subscriber and the buyer subscriber utilizing the host server 22 until the parties come to an agreement on final terms for the sale of the financial instrument or otherwise end negotiations. Because the information system 10 of the present invention allows for communication to be established directly between the buyer subscriber 18 and seller subscriber 14, and further provides entity identity information for both the buyer subscriber 18 and the seller subscriber 14 so that the parties are aware of each other's identities (as discussed above), the parties can avoid going through a third-party anonymous system or entity. In other words, since direct ordering occurs between a fully disclosed buyer and a fully disclosed seller, no intermediary or inter-dealer broker is required in the present invention. As such, it can be seen that the cost of financial instruments associated with the present invention is reduced by eliminating the opportunity for a middle markup (e.g., from middle brokerage fees, or buy/sell clearing and ticketing costs) which are a consequence of traditional and prior electronic commerce networks.

Although the order requests and order responses are described in one embodiment as being inputted via the “Comment” boxes 164 and 184 and displayed via the “Messaging/History” boxes 169 and 179 of the seller interface 50 and the buyer interface 100, it should be understood that the order requests and order responses can be inputted and/or displayed using any appropriate technique currently available or developed in the future for electronic communication. For example, the order-requests and order responses can be inputted and displayed using a technique that is used to input and display email messages. However, it is preferred that the host server 22 provide real-time distribution of information so that the seller subscribers 14 and the buyer subscribers 18 can communicate details of offerings, bids and orders back and forth to one another in real-time through the host server 22. Therefore, communication and messaging technologies, now existing or later developed, which allow information to be sent and received in real-time between the seller subscriber systems 26, the buyer subscriber systems 30 and the host server 22 are preferably utilized to implement the present invention.

Further, each order request transmitted by the buyer subscriber 18 and each order response transmitted by the seller subscriber 14 preferably remain displayed in the “Messaging/History” boxes 169 and 179 so that they can be readily reviewed by the buyer subscriber 18 or the seller subscriber 14 at any point during the transaction. Also, to provide a recording of the communications and negotiations between the seller subscriber 14 and the buyer subscriber 18, the host server 22 can store the requests and the responses in a transaction report. Preferably, the transaction report is adapted so as to meet compliance regulations that require firms to monitor, audit and store electronic communications, such as emails and instant messages.

In one embodiment, the information system 10 of the present invention is further adapted to facilitate the execution of the transaction between the seller subscriber 14 and the buyer subscriber 18 for the financial instrument identified by the listing by generating an order execution ticket. In general, the order execution ticket includes information which can be utilized by either the buyer subscriber 18 or the seller subscriber 14 to interface with buyer's and seller's operations departments and the applicable clearing house(s) to assist in the generation of confirmations and the transfer of and payment for the financial instrument all outside of the system. Such information can include for example at least a portion of the entity information for the seller subscriber 14 and buyer subscriber 18, and the final terms agreed upon for the sale of the financial instrument, description of the financial instrument, CUSIP, trade date and/or time, setlement date, yield, price, instructions or the like. Also, the ticket can incorporate the transaction report which contains the requests transmitted by the buyer subscriber 18 and the responses transmitted by the seller subscriber 14 during the negotiation process for the financial instrument.

Once the seller subscriber 14 and the buyer subscriber 18 are satisfied with the terms of the transaction negotiated through their communication, at least one of the seller subscriber 14 or the buyer subscriber 18 can cause the host server 22 to generate the order execution ticket. In one embodiment, the host server 22 generates the order execution ticket when the host server 22 receives an order request indicative of a final bid from the buyer subscriber 18 being accepted by seller subscriber 14 or an order response indicative of an acceptance of the final offer from the seller subscriber 14 by the buyer subscriber 18.

In one embodiment, the order request indicative of the final order bid is transmitted by the buyer subscriber 18 via a “Final Bid” check box 200 and the “Submit Bid” button 178 provided in the “Order” screen 160 of the buyer interface 100 (see FIG. 19). The host server 22 collects information indicative of the final terms as they appear in the entry fields of the “Order” screen 160 and transmits the information indicative of the final terms to the seller subscriber 14. Once the seller subscriber 14 verifies the final terms, the seller subscriber 14 transmits the response indicative of the acceptance of the final bid to the host server 22. In one embodiment, the order response indicative of the acceptance is transmitted by the seller subscriber 14 via a “Hit Bid” button 210 provided in the seller interface 50 (see FIG. 20).

Preferably, the host server 22 further allows at least one of the seller subscriber 14 or the buyer subscriber 18 to cancel or reject the final bid or final offer so as to terminate the transaction. In one embodiment, upon cancellation or rejection of the final bid or final offer, the parties can reenter negotiations, and the exchange of requests and responses continues. In another embodiment, at least one of the seller subscriber 14 or the buyer subscriber 18 can end negotiations for the financial instrument identified by the listing such that the host server 22 will no longer exchange order requests and order responses between the parties permanently, for a predetermined period or until a predetermined trigger occurs (e.g., when the buyer subscriber 18 re-selects the listing in the ticker list 112).

As discussed above, once the host server 22 receives the-request indicative of the final bid from the buyer subscriber 18 and the order response indicative of the acceptance of the final bid from the seller subscriber 14, the host server 22 generates the order ticket. The host server 22 then transmits the order ticket to the seller subscriber 14 so that the seller subscriber 14 can utilize the order ticket in executing the transaction and transferring the fixed-income instrument to the buyer subscriber 18 outside of the system, and/or to the buyer subscriber 18 clearing agent so that the buyer subscriber 18 can utilize the order ticket to assist in transferring value to the seller subscriber 14 outside of the system. For example, the order ticket can be outputted as a hard copy (e.g., a paper printout) or soft copy (e.g., file or email) and utilized by a back office system of the buyer subscriber 18 and/or seller subscriber 14 for reconciliation, clearing and generating confirmations.

The order ticket can also be used to automatically remove or edit the inventory listing stored on the host server 22. For example, the order ticket can be utilized by an inventory management system of the seller subscriber 14 to remove or edit the listing accordingly. The seller subscriber 14 will be asked if they want to reduce their inventory position by the order quantity. If so, the offering quantity will be reduced automatically.

In one embodiment, the seller interface 50 and/or the buyer interface 100 further include an “Order History” window 250, as shown for example in FIG. 21. The “Order History” window 250 functions similarly in the seller interface 50 for the seller subscriber 14 as it does in the buyer interface 100 for the buyer subscriber 18, therefore for purposes of brevity and clarity, the “Order History” window 250 is described further below with respect to a subscriber in general.

The “Order History” window 250 allows the seller subscriber 14 or the buyer subscriber 18 to view information relating to orders that were transacted by the subscriber 18. For example, the “Order History” window 250 can display a reference order number, a date and time the order was placed, an identity of the other transacting entity, and a transaction status for the listing. The “Order History” window 250 can also provide information indicative of whether the subscriber was acting as a buyer or seller in the transaction. Further, terms such as for example the instrument type, quantity, CUSIP, description, bid price, and ask price can be displayed. Also, the “Order History” window 250 can include a means which allows the subscriber to search for particular transactions, e.g., transactions falling within a specified time frame.

The present invention contemplates that the information system 10 can be assessable as a free utility, or as a service charged to the seller subscribers 14 and/or the buyer subscribers 18. For example, in one embodiment, the seller subscriber 14 is charged per listing that is posted or stored on the host server 22, rather than by the quantity of the financial instrument that is transacted. Alternatively, the seller subscriber 14 can be charged on a per-order fixed fee, a per-time frame, or a subscription basis (or under any other appropriate billing means). As another example, the buyer subscriber 18 can be charged on a per-use a per-order fixed fee, a per-time frame, or a subscription basis (or under any other appropriate billing means).

From the above description, it is clear that the present invention is well adapted to carry out the objectives and to attain the advantages mentioned herein, as well as those inherent in the invention. Although the foregoing invention has been described in some detail by way of illustration and example for purposes of clarity of understanding, it will be apparent to those skilled in the art that certain changes and modifications may be practiced without departing from the spirit and scope of the present invention, as described herein. As such, those skilled in the art will appreciate that the conception upon which this disclosure is based may readily be utilized as a basis for the designing of other structures, methods, and systems for carrying out the several purposes of the present invention. As such, it should be understood that the invention is not limited to the specific and preferred embodiments described herein, including the details of construction and the arrangements of the components as set forth in the above description or illustrated in the drawings. Further, it should be understood that the phraseology and terminology employed herein are for the purpose of description and should not be regarded as limiting.

What is claimed is:

1. A method for facilitating transactions relating to financial instruments, the method comprising:
storing on a host server listings, each listing identifying a different financial instrument being offered for sale by one of seller subscribers, each of the seller subscribers being associated with a seller subscriber system;
receiving via the host system an information code from a buyer subscriber system associated with a buyer subscriber, the information code identifying a selected listing with the selected listing being one of the listings stored on the host server; and
connecting, via the host server, the buyer subscriber system sending the information code and the seller subscriber system associated with the seller subscriber offering the financial instrument identified by the selected listing in the information code so as to allow direct communication between the buyer subscriber system and the seller subscriber system via the host server for the purpose of facilitating at least one of a negotiation or a consummation of a transaction between the buyer subscriber and the seller subscriber for the financial instrument identified by the selected listing.

2. The method of claim 1, wherein the financial instruments identified by the listings are bonds.

3. The method of claim 1, further comprising the step of passing to the buyer subscriber system sending the information code an entity identity via the host server, the entity identity identifying the seller subscriber offering the financial instrument identified by the selected listing in the information code for the purpose of disclosing information from which the buyer subscriber can identify the seller subscriber offering the financial instrument identified by the selected listing in the information code.

4. The method of claim 1, further comprising the step of passing to the seller subscriber system associated with the seller subscriber offering the financial instrument identified by the selected listing in the information code an entity identity via the host server, the entity identity identifying the buyer subscriber associated with the buyer subscriber system sending the information code for the purpose of disclosing information from which the seller subscriber can identify the buyer subscriber.

5. The method of claim 1, wherein in the step of connecting the buyer subscriber system and the seller subscriber system, the direct communication between the buyer subscriber system and the seller subscriber system occurs in real-time.

6. The method of claim 1, wherein in the step of connecting the buyer subscriber system and the seller subscriber system, the direct communication between the buyer subscriber system and the seller subscriber system is established by at least one of receiving, via the host server, a request from the buyer subscriber system and passing, via the host server, the request to the seller subscriber system, and receiving, via the host server, a response from the seller subscriber system and passing, via the host server, the response to the buyer subscriber system.

7. A method for facilitating transactions relating to financial instruments, the method comprising:
providing a host server to selectively permit access to listings associated with seller subscribers, each of the listings identifying a different financial instrument being offered for sale by one of the seller subscribers, each of the seller subscribers being associated with a seller subscriber system;
receiving via the host server an information code from a buyer subscriber system associated with a buyer subscriber, the information code identifying a selected listing with the selected listing being one of the listings associated with the seller subscribers; and
connecting, via the host server, the buyer subscriber system sending the information code and the seller subscriber system associated with the seller subscriber offering the financial instrument identified by the selected listing in the information code so as to allow direct communication between the buyer subscriber system and the seller subscriber system via the host server for the purpose of facilitating at least one of a negotiation or a consummation of a transaction between the buyer subscriber and the seller subscriber for the financial instrument identified by the selected listing.

8. An information system for financial instruments comprising:
a host server having access to listings, each listing identifying a different financial instrument being offered for sale by one of a seller subscriber, each seller subscriber being associated with a seller subscriber system;
the host server receiving an information code from a buyer subscriber system associated with a buyer subscriber, the information code identifying a selected listing with the selected listing being one of the listings accessible by the host server; and
the host server connecting the buyer subscriber system sending the information code and the seller subscriber system associated with the seller subscriber offering the financial instrument identified by the selected listing in the information code so as to allow direct communication between the buyer subscriber system and the seller subscriber system via the host server for the purpose of facilitating at least one of a negotiation or a consummation of a transaction between the buyer subscriber and the seller subscriber for the financial instrument identified by the selected listing.

9. The information system of claim 8, wherein the financial instruments identified by the listings are bonds.

10. The information system of claim 8, wherein the host server further passes to the buyer subscriber system sending the information code an entity identity identifying the seller subscriber offering the financial instrument identified by the selected listing in the information code for the purpose of disclosing information from which the buyer subscriber can identify the seller subscriber offering the financial instrument identified by the selected listing in the information code.

11. The information system of claim 8, wherein the host server further passes to the seller subscriber system associated with the seller subscriber offering the financial instrument identified by the selected listing in the information code an entity identity identifying the buyer subscriber associated with the buyer subscriber system sending the information code for the purpose of disclosing information from which the seller subscriber can identify the buyer subscriber.

12. The information system of claim 8, wherein the direct communication between the buyer subscriber system and the seller subscriber system occurs in real-time.

13. The information system of claim 8, wherein the host server allows for direct communication between the buyer subscriber system and the seller subscriber system by at least one of receiving an order request from the buyer subscriber system and passing the order request to the seller subscriber system, and receiving an order response from the seller subscriber system and passing the order response to the buyer subscriber system.

14. An information system for financial instruments comprising:
a host server having access to listings, each listing including at least one financial instrument characteristic, identifying a financial instrument being offered for sale by one seller subscriber, the seller subscriber being associated with a seller subscriber system;
the host server receiving a search request from a buyer subscriber system associated with a buyer subscriber, the search request identifying at least one financial instrument characteristic;
the host server passing to the buyer subscriber system a search result identifying one or more listings accessible by the host server that include at least one financial instrument characteristic identified in the search request;
the host server receiving from the buyer subscriber system an information code, the information code identifying a selected listing with the selected listing being one of the listings identified in the search result, the host server further receiving an order request from the buyer subscriber system for the financial instrument identified by the selected listing in the information code; and
the host server passing the order request to the seller subscriber system associated with the seller subscriber offering for sale the financial instrument identified by the selected listing in the information code for the purpose of facilitating at least one of a negotiation or a consummation of a transaction between the buyer subscriber and the seller subscriber for the financial instrument identified by the selected listing.

15. The information system of claim 14, wherein the financial instruments identified by the listings are fixed income securities.

16. The information system of claim 14, wherein the host server further passes to the buyer subscriber an entity identity for each seller subscriber offering for sale one of the one or more listings identified in the search result for the purpose of disclosing information from which the buyer subscriber can identify each seller subscriber offering for sale one of the one or more listings identified in the search result.

17. The information system of claim 14, wherein the host server further passes to the buyer subscriber system sending the information code an entity identity identifying the seller subscriber offering the financial instrument identified by the selected listing in the information code for the purpose of disclosing information from which the buyer subscriber can identify the seller subscriber offering the financial instrument identified by the selected listing in the information code.

18. The information system of claim 14, wherein the host server further passes to the seller subscriber system associated with the seller subscriber offering the financial instrument identified by the selected listing in the information code an entity identity identifying the buyer subscriber associated with the buyer subscriber system sending the information code for the purpose of disclosing information from which the seller subscriber can identify the buyer subscriber.

19. The information system of claim 14, wherein the host server passes the order request to the seller subscriber system associated with the seller subscriber offering for sale the financial instrument identified by the selected listing in the information code in real-time.

20. The information system of claim 14, wherein the host server further receives a log-in signal from at least one seller subscriber system associated with one of the seller subscribers, the host server utilizing the log-on signal received from at least one seller subscriber system to transmit a presence indicator to the buyer subscriber system for the purpose of indicating to the buyer subscriber that the seller subscriber associated with the seller subscriber system is logged on and available to receive and respond to order requests.

21. The information system of claim 20, wherein the presence indicator is transmitted with search result.

22. The information system of claim 14, wherein the host server further receives a response from the seller subscriber system associated with the seller subscriber offering for sale the financial instrument identified by the selected listing in the information code and passes the order response to the buyer subscriber system sending the order request.

23. The method of claim 22, wherein the host server passes the response to the buyer subscriber system sending the order request in real-time.

24. The information system of claim 22, wherein the host server further stores the order requests received from the buyer subscriber system and the responses received from the seller subscriber system in a report.

25. The information system of claim 22, wherein the host server further generates an order ticket after receiving an order request indicative of a final bid or acceptance of offer from the buyer subscriber system and an order response indicative of an acceptance of the final bid or acceptance of initial offer from the seller subscriber system.

26. The information system of claim 25, wherein the host server further passes the order ticket to the seller subscriber system so that the seller subscriber can utilize the order ticket in transferring the financial instrument to the buyer subscriber outside of the system.

27. The information system of claim 25, wherein the host server further passes the order ticket to the buyer subscriber system so that the buyer subscriber can utilize the order ticket in transferring value to the seller subscriber for the transfer of the financial instrument outside of the system.

28. The information system of claim 14, wherein host server uses a web-server to communicate via the Internet.

29. The information system of claim 14, wherein at least one financial instrument characteristic of the listing is selected from a group consisting of an instrument type, a description or name, a price, a quantity, an initial value, a current value, a future value, a coupon rate, a coupon type, an instrument form, an instrument use, an issue date, a maturity date, a call date, a payment frequency, a yield, a concession, a spread, a benchmark, a credit quality rating, a tax status, an issuer identity, a standard identification number, an agency name, an agency relationship, a material event, a restriction for the financial instrument, and a buyer qualification.

30. The information system of claim 14, wherein at least some of the listings stored on the host server have a user permission associated therewith, the user permission being utilized by the host server to determine at least one of whether the listing is to be identified in the search result passed to the buyer subscriber and whether the buyer subscriber can pass requests for the financial instrument identified by the listing.

31. A method for facilitating transactions relating to financial instruments, the method comprising:
under control of a buyer subscriber system, displaying information identifying a financial instrument; and
sending a log-in signal identifying a buyer subscriber and an order request for the financial instrument to a host server;
under control of a seller subscriber system associated with a seller subscriber offering for sale the financial instrument, sending a log-in signal identifying the seller subscriber and sending a response for the financial instrument to a host server;
under control of the host server, receiving the request from the buyer subscriber system;
retrieving entity identity information previously stored for the buyer subscriber identified by the log-in signal;
receiving the order response from the seller subscriber system;
retrieving entity identity information previously stored for the seller subscriber identified by the log-in signal; and
sending the order request to the seller subscriber system and at least a portion of the entity identity information for the buyer subscriber, and sending the response to the buyer subscriber system and at least a portion of the entity identity information for the seller subscriber so as to connect the seller subscriber system and the buyer subscriber system and allow communication between the seller subscriber and the buyer subscriber.

32. A host server for connecting a buyer subscriber system associated with a buyer subscriber and a seller subscriber system associated with a seller subscriber, the host server comprising:
a data storage medium storing listing information for financial instruments;
a data storage medium storing entity identity information for seller subscribers, each of the seller subscribers offering for sale at least one of the financial instruments;
a data storage medium storing entity identity information for buyer subscribers;
a receiving component for receiving a request from a buyer subscriber system, the request including an indication of one of the buyer subscribers and an indication of one of the financial instruments;
a retrieving component for retrieving entity information for the indicated buyer subscriber and for the seller subscriber offering for sale the indicated financial instrument;
a connecting component for connecting the buyer subscriber system associated with the indicated buyer subscriber and a seller subscriber system associated with the seller subscriber offering for sale the indicated financial instrument so as to allow direct communication between the buyer subscriber system and the seller subscriber system for the purpose of facilitating at least one of a negotiation or a consummation of a transaction between the buyer subscriber and the seller subscriber for the indicated financial instrument.

33. A method for negotiating for a financial instrument using a buyer subscriber system, the method comprising:
displaying listing information identifying a financial instrument; and
sending to a host server an identification of a buyer subscriber and an order request for the financial instrument for the purpose of establishing a connection via the host server to a seller subscriber system associated with a seller subscriber offering for sale the identified financial instrument.
